(19) United States
(12) Patent Application Publication
(10) Pub. No.: US 2025/0200999 A1
(43) Pub. Date: Jun. 19, 2025

(54) ELECTRONIC DEVICE FOR DETECTING OBJECTS IN VEHICLE INTERIOR AND OPERATING METHOD THEREOF

(71) Applicant: THINKWARE CORPORATION, Seongnam-si (KR)

(72) Inventors: Yosep Park, Seongnam-si (KR); Yechan Choi, Seongnam-si (KR); Taekyu Han, Seongnam-si (KR)

(73) Assignee: THINKWARE CORPORATION, Seongnam-si (KR)

(21) Appl. No.: 18/978,652

(22) Filed: Dec. 12, 2024

(30) Foreign Application Priority Data
Dec. 13, 2023 (KR) 10-2023-0180738

(51) Int. Cl. G06V 20/59; G06V 10/82; G06V 20/56; G06V 40/16; G06V 40/18

(52) U.S. Cl. CPC G06V 20/597; G06V 10/82; G06V 20/588; G06V 40/165; G06V 40/171; G06V 40/18

(57) ABSTRACT

An operation method of an electronic device for monitoring a driver's state according to one embodiment includes: detecting feature points of a driver's face in a vehicle interior image captured by an interior camera installed in the electronic device; transforming coordinates of the detected feature points into a frontal coordinate system; and determining the driver's state using distances between coordinates of at least two of the transformed feature points, wherein the frontal coordinate system is a coordinate system of an image captured by the interior camera from directly in front of the driver's face.

### TECHNICAL FIELD

The present invention relates to an electronic device and its operating method for detecting moving objects in a vehicle interior.

### BACKGROUND ART

The most important aspects of vehicle operation are safe driving and accident prevention. To this end, various auxiliary devices are installed in vehicles to control vehicle posture and component functions, along with safety devices such as seat belts and airbags. Furthermore, recently there has been an increasing trend of installing various devices in vehicles such as car video recorders (Car Video Recorder, Dashboard Camera, etc.), event data recorders (Event Data Recorder (EDR)) that store event data generated by vehicles, which store video data around the vehicle and sensor data from various sensors installed in electronic devices mounted in or on the vehicle, enabling determination of accident causes when vehicle accidents occur. Moreover, portable user terminals such as smartphones and tablet PCs equipped with communication chips capable of accessing the internet through cellular-based mobile telecommunication networks and/or Wi-Fi networks following IEEE 802.11 standards are also being utilized as various vehicle electronic devices that acquire video data around vehicles and gyro-sensor, accelerometer, GPS signals, etc., and through various user applications assist driver operation, perform autonomous driving, or provide route guidance to drivers.

Meanwhile, vehicle theft incidents frequently occur not only overseas in countries like the United States but also domestically. Additionally, there are cases where infants and young children are left unattended in parked vehicles, resulting in fatalities. Furthermore, connected services that provide various services to users by interworking with users' smartphones through wireless networks are becoming popularized in vehicles equipped with communication-capable electronic devices, and recently, the proportion of vehicles equipped with cameras for monitoring not only the external environment of the vehicle-front, rear, and sides-but also the internal environment is increasing.

### SUMMARY OF THE INVENTION

From the above perspective, this disclosure can provide a method to detect objects in the vehicle interior and, if mobility of detected objects is identified, notify information about the identified objects to the vehicle user and/or emergency agencies to prevent accidents involving abandoned infants, animals, or vehicle theft during parking.

Regarding object monitoring in the vehicle interior environment, electronic devices and operating methods according to various embodiments are provided.

According to one embodiment, an electronic device and operating method for detecting moving objects in a vehicle interior using interior images can be provided.

According to another embodiment, an electronic device and operating method for acquiring vehicle interior images can be provided.

According to another embodiment, an electronic device and operating method for generating background images of vehicle interior to be used for detecting moving objects from vehicle interior images during parking can be provided.

According to another embodiment, an electronic device and operating method for detecting moving objects in current vehicle interior images using vehicle interior background images can be provided.

According to another embodiment, an electronic device and operating method capable of detecting moving objects by dividing current vehicle interior images can be provided.

According to another embodiment, an electronic device and operating method for acquiring information about moving objects when moving objects are detected in the vehicle interior can be provided.

Meanwhile, regarding driver state monitoring, electronic devices and operating methods according to various embodiments are provided.

According to one embodiment, an electronic device and operating method for monitoring driver state during vehicle operation can be provided.

According to another embodiment, an electronic device and operating method for acquiring mounting angles of vehicle black boxes can be provided.

According to another embodiment, an electronic device and operating method for monitoring driver state from images using cameras not positioned directly in front of the driver can be provided.

According to another embodiment, an electronic device and operating method for determining driver state using feature points detected from driver faces in vehicle black box interior images can be provided.

According to one embodiment, a method of operating an electronic device for detecting objects in a vehicle interior comprises: acquiring at least one interior image of the vehicle; generating a reference image using the at least one interior image; and detecting an object in the vehicle interior based on at least one divided region of the generated reference image and at least one divided region of a target image that is a vehicle interior image acquired after the reference image is generated.

In one implementation, acquiring the at least one interior image comprises capturing the vehicle interior at a predetermined frame rate for a predetermined time period in a parking mode of the vehicle. The parking mode is determined by detecting an ignition state of the vehicle.

Generating the reference image comprises setting a region of interest for each of the at least one interior image; and combining each interior image with the set region of interest.

Setting the region of interest comprises setting the region of interest according to a preset method to minimize a window area of the vehicle.

The preset method comprises excluding a first ratio of the image from each left and right side based on a bottom center point of the reference image, and excluding a second ratio of the image from a top of the reference image.

Detecting the object comprises: dividing the target image into multiple regions; and detecting the object in each of the divided multiple regions.

Detecting the object comprises: detecting the object by sequentially applying multiple grid containers to the reference image and the target image in ascending order according to division sizes of the grid containers.

The multiple grid containers include multiple grid containers having a same division size, the multiple grid containers having the same division size have grid cell starting positions set differently from each other, and the multiple grid containers having the same division size with differently set grid cell starting positions are applied together to the interior image.

Detecting the object comprises discontinuing object detection using a next sequential grid container when the object is detected using a currently applied grid container.

Detecting the object comprises continuing object detection using a next sequential grid container when the object is detected using a currently applied grid container.

The method further includes transmitting notification information about the object detection to a terminal of the vehicle user.

Additionally, the method may involve acquiring information about the detected object and transmitting the acquired object information to a terminal of the vehicle user.

Acquiring the object information comprises classifying the object based on machine learning and acquiring class information of the object based on the classification result.

If the object is a person, classifying the object may comprise classifying whether the person is an adult, child, or infant based on a ratio between sizes of objects in the reference image and the person.

An electronic device for detecting objects in a vehicle interior comprises: a camera configured to acquire at least one interior image of the vehicle; and a processor configured to: generate a reference image using the acquired at least one interior image; and detect objects in the vehicle interior based on at least one divided region of the reference image and at least one divided region of a target image, which is a vehicle interior image acquired after the reference image is generated.

The camera may be further configured to capture the vehicle interior at a predetermined frame rate for a predetermined time period in a parking mode, while the processor determines the parking mode by detecting the ignition state of the vehicle.

The processor sets a region of interest for each of the at least one interior image and combines each interior image with the set region of interest to generate the reference image.

The processor sets the region of interest according to a preset method to minimize a window area of the vehicle.

The preset method may comprise excluding a first ratio of the image from each left and right side based on a bottom center point of the reference image and excluding a second ratio of the image from a top of the reference image.

The processor divides the target image into multiple regions and detects the object in each of the divided multiple regions.

The processor detects the object by sequentially applying multiple grid containers to the reference image and the target image in ascending order according to division sizes of the grid containers.

The multiple grid containers include multiple grid containers having a same division size, the multiple grid containers having the same division size have grid cell starting positions set differently from each other, and the multiple grid containers having the same division size with differently set grid cell starting positions are applied together to the interior image.

The processor discontinues object detection using a next sequential grid container when the object is detected using a currently applied grid container.

The processor continues object detection using a next sequential grid container when the object is detected using a currently applied grid container.

In addition, the electronic device may comprise a communication circuit configured to transmit notification information about the object detection to a terminal of the vehicle user.

The processor acquires information about the detected object and the electronic device further comprises a communication circuit configured to transmit the acquired object information to a terminal of the vehicle user.

The processor is further configured to classify the object based on machine learning and acquire class information of the object based on the classification result.

If the object is a person, the processor is further configured to classify whether the person is an adult, child, or infant based on a ratio between sizes of objects in the reference image and the person.

According to another embodiment, a method of operating an electronic device for monitoring a driver's state comprises: detecting feature points of a driver's face in a vehicle interior image captured by an interior camera installed in the electronic device; transforming coordinates of the detected feature points into a frontal coordinate system; and determining the driver's state using distances between coordinates of at least two of the transformed feature points. The frontal coordinate system is a coordinate system of an image captured by the interior camera from directly in front of the driver's face.

Transforming the coordinates into coordinates in the frontal coordinate system may comprise acquiring a mounting angle of the interior camera, and transforming the coordinates of the feature points into coordinates in the frontal coordinate system using the mounting angle of the interior camera.

Acquiring the mounting angle of the interior camera may comprise detecting straight lanes in a front image captured by a front camera equipped in the electronic device, detecting a vanishing point of the detected straight lanes, acquiring a mounting angle of the front camera by comparing the detected vanishing point with a center point of the front image, and acquiring the mounting angle of the interior camera from the mounting angle of the front camera.

Acquiring the mounting angle of the interior camera may comprise acquiring the mounting angle of the interior camera using a gyro sensor, weighted summing the mounting angle of the interior camera acquired from the mounting angle of the front camera and the mounting angle of the interior camera acquired using the gyro sensor, and determining the weighted summed value as a final mounting angle of the interior camera.

Detecting the feature points of the driver's face comprises detecting a center point of a left eye as a first feature point, a center point of a right eye as a second feature point, and a center point of a nose as a third feature point; and determining the driver's state is based on a ratio of the distance between the first and third feature points to the distance between the second and third feature points.

Determining the driver's state comprises determining the driver's state as not gazing forward when the ratio of distances is greater than or equal to a first reference value, or less than a second reference value, and determining the driver's state as gazing forward when the ratio of distances is greater than or equal to the second reference value and less than the first reference value.

At least multiple feature points among the detected feature points of the driver's face are detected from one feature portion among feature portions of the driver's face, and the feature portions of the driver's face include at least one of eyes, nose, mouth, eyebrows, and facial contour lines.

Determining the driver's state may comprise determining the driver's state, for at least one eye among the driver's left eye and right eye, based on a ratio (C), where (C) is the ratio of the distance between the end feature points of the one eye to the sum of distances between at least one upper eye feature point and its corresponding lower eye feature point.

Determining the driver's state may comprise determining the driver's state as drowsy when the ratio (C) remains less than or equal to a third reference value for at least a predetermined time period.

Determining the driver's state may comprise determining at least one of the driver's drowsiness and the driver's forward gaze state by a machine learning model trained with at least some of the detected feature points of the driver's face.

An electronic device for monitoring a driver's state, comprises: an interior camera configured to capture a vehicle interior; and a processor configured to: detect feature points of a driver's face in a vehicle interior image captured by the interior camera, transform coordinates of the detected feature points into coordinates in a frontal coordinate system, and determine the driver's state using distances between coordinates of at least two of the transformed feature points. The frontal coordinate system is a coordinate system of an image captured by the interior camera from directly in front of the driver's face.

The processor acquires a mounting angle of the interior camera and transforms the coordinates of the feature points into coordinates in the frontal coordinate system using the mounting angle of the interior camera.

The processor detects straight lanes in a front image captured by a front camera equipped in the electronic device, detect a vanishing point of the detected straight lanes, acquire a mounting angle of the front camera by comparing the detected vanishing point with a center point of the front image, and acquire the mounting angle of the interior camera from the mounting angle of the front camera.

The processor acquires the mounting angle of the interior camera using a gyro sensor, perform a weighted summation of the mounting angle of the interior camera acquired from the mounting angle of the front camera and the mounting angle of the interior camera acquired using the gyro sensor, and determine the weighted summed value as a final mounting angle of the interior camera.

The processor detects the feature points of the driver's face by detecting a center point of a left eye as a first feature point, a center point of a right eye as a second feature point, and a center point of a nose as a third feature point, and determine the driver's state based on a ratio of the distance between the first and third feature points to the distance between the second and third feature points.

The processor determines the driver's state as not gazing forward when the ratio of distances is greater than or equal to a first reference value, or less than a second reference value, and determine the driver's state as gazing forward when the ratio of distances is greater than or equal to the second reference value and less than the first reference value.

At least multiple feature points among the detected feature points of the driver's face are detected from one feature portion among feature portions of the driver's face, and the feature portions of the driver's face include at least one of eyes, nose, mouth, eyebrows, and facial contour lines.

The processor determines the driver's state based on a ratio (C), where (C) is the ratio of the distance between end feature points of one eye among multiple eye feature points detected from at least one eye among the driver's left eye and right eye, to a sum of distances between at least one upper eye feature point and its corresponding lower eye feature point of the one eye.

The processor determines the driver's state as drowsy when the ratio (C) remains less than or equal to a third reference value for at least a predetermined time period.

The processor determines at least one of the driver's drowsiness and the driver's forward gaze state by a machine learning model trained with at least some of the detected feature points of the driver's face.

### Advantageous Effects

Based on vehicle interior images captured by electronic devices mounted in vehicles, moving objects (people, animals, etc.) in vehicles can be detected and the detected information can be notified to vehicle user terminals. Accordingly, accidents involving abandoned infants and young children in vehicles or vehicle theft can be prevented. Additionally, the processor of in-vehicle electronic devices can classify moving objects in vehicles using image data acquired through cameras and pre-learned machine learning, enabling detection of abnormal states inside vehicles using only in-vehicle electronic devices without identifying abnormal states from outside vehicles.

Furthermore, driver operating state/behavioral state etc. can be monitored based on vehicle interior images acquired through cameras installed in vehicles during vehicle operation. Through this, even vehicles that did not support driver monitoring systems during vehicle manufacturing can provide driver monitoring systems through embodiments according to this invention, helping drivers perform safe operation.

### BRIEF DESCRIPTION OF DRAWINGS

The following drawings were created to explain specific examples of this specification. The specific device names or specific signal/message/field names recorded in the drawings are presented as examples, so the technical features of this specification are not limited to the specific names used in the following drawings.

FIG. 1 is a diagram explaining a vehicle service system applicable to embodiments of this invention.

FIG. 2A is a diagram explaining the configuration of one example of a vehicle electronic device applicable to embodiments of this invention.

FIG. 2B is a diagram explaining another example configuration of a vehicle electronic device applicable to embodiments of this invention.

FIG. 3 is a diagram explaining the configuration of a vehicle service providing server applicable to embodiments of this invention.

FIG. 4 is a diagram explaining the configuration of a user terminal device according to embodiments of this invention.

FIG. 5 is a diagram explaining the operation of an electronic device training a neural network based on a set of training data according to embodiments of this invention.

FIG. 6 is a diagram explaining the configuration of an electronic device according to embodiments of this invention.

FIG. 7 is a diagram explaining examples of interior images captured according to the first embodiment of this invention.

FIG. 8 is a diagram explaining an example of setting a region of interest according to the first embodiment of this invention.

FIG. 9 is a diagram showing an example of a background image generated from region of interest images according to the first embodiment of this invention.

FIG. 10 is a diagram illustrating a case where no moving object exists in the vehicle when verifying moving objects in the vehicle based on the background image according to the first embodiment of this invention.

FIG. 11 is a diagram illustrating a case where a moving object exists in the vehicle when verifying moving objects in the vehicle based on the background image according to the first embodiment of this invention.

FIG. 12A is a diagram illustrating a case of detecting moving objects by displaying regions of the reference image in a grid pattern and dividing it into multiple grid cells according to the displayed grid pattern according to the first embodiment of this invention.

FIG. 12B is a diagram explaining the concept of grid containers and grid cells in the first embodiment of this invention.

FIG. 12C is a diagram explaining a case where grid containers have the same division size but different starting positions of grid cells according to the first embodiment of this invention.

FIG. 12D is a diagram explaining various examples of motion vectors in the first embodiment of this invention.

FIG. 12E is a diagram explaining an example of using a grid container larger than the image considering cases where the grid container moves according to motion vectors according to the first embodiment of this invention.

FIG. 12F is a diagram explaining various examples of how grid cell coordinates are set according to the first embodiment of this invention.

FIG. 13A and FIG. 13B are diagrams explaining the operation of an electronic device according to the first embodiment of this invention.

FIG. 14 is a diagram explaining an example of classifying the age group of a person who is a moving object according to the first embodiment of this invention.

FIG. 15 is a diagram explaining the operating method of an electronic device (600) for DMS according to the second embodiment of this invention.

FIG. 16 is a diagram explaining an example of the electronic device detecting straight lanes using a forward image according to the second embodiment of this invention.

FIG. 17 is a diagram explaining an example of the electronic device determining a vanishing point of straight lanes according to the second embodiment of this invention.

FIG. 18 is a diagram explaining how the electronic device estimates the mounting angle of the forward camera from the vanishing point according to the second embodiment of this invention.

FIG. 19 is a diagram explaining the concepts of roll, yaw, and pitch in the second embodiment of this invention.

FIG. 20 is a diagram explaining an example of setting a region of interest where the driver is located in the interior image according to the second embodiment of this invention.

FIG. 21 is a diagram explaining an example where one feature point is detected from a characteristic part of the driver's face in the second embodiment of this invention.

FIG. 22 is a diagram explaining an example where multiple feature points are detected from one characteristic part of the driver's face according to the second embodiment of this invention.

FIG. 23 is a diagram explaining an example of determining the driver's gaze direction using feature points detected in FIG. 21 according to the second embodiment of this invention.

FIG. 24 is a diagram explaining an example of determining whether the driver is in a drowsy driving state using the feature points of FIG. 22 according to the second embodiment of this invention.

### DETAILED DESCRIPTION OF THE INVENTION

Hereinafter, some embodiments of this specification will be described in detail through exemplary drawings. In adding reference numerals to components in each drawing, the same components will have the same reference numerals as much as possible, even if they appear in different drawings. Also, in explaining embodiments, if it is determined that detailed descriptions of related known configurations or functions would impede understanding of the embodiments, such detailed descriptions will be omitted.

In describing components of this specification, terms such as first, second, A, B, (a), (b), etc. may be used. These terms are only used to distinguish one component from other components, and the nature, order, or sequence of the corresponding component is not limited by these terms. Also, unless defined differently, all terms used here, including technical or scientific terms, have the same meaning as generally understood by those skilled in the art. Terms defined in generally used dictionaries should be interpreted as having meanings consistent with their contextual meanings in the relevant art and should not be interpreted in an idealistic or overly formal sense unless expressly defined otherwise in this application.

In this specification, “A or B” may mean “only A”, “only B”, or “both A and B”. In other words, “A or B” in this specification can be interpreted as “A and/or B”. For example, “A, B or C” in this specification may mean “only A”, “only B”, “only C”, or “any combination of A, B and C”.

In this specification, slashes (/) or commas may mean “and/or”. For example, “A/B” may mean “A and/or B”. Accordingly, “A/B” may mean “only A”, “only B”, or “both A and B”. For example, “A, B, C” may mean “A, B or C”.

In this specification, “at least one of A and B” may mean “only A”, “only B”, or “both A and B”. Also, in this specification, expressions like “at least one of A or B” or “at least one of A and/or B” can be interpreted the same as “at least one of A and B”.

Also, in this specification, “at least one of A, B and C” may mean “only A”, “only B”, “only C”, or “any combination of A, B and C”. Also, “at least one of A, B or C” or “at least one of A, B and/or C” may mean “at least one of A, B and C”.

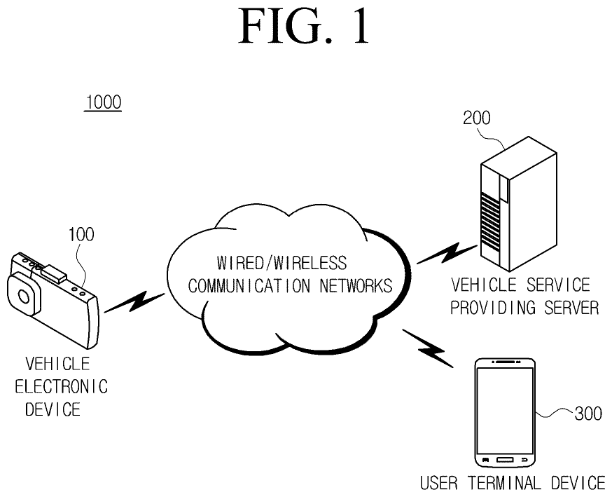

FIG. 1 is a diagram explaining a vehicle service system applicable to embodiments of this invention.

In this specification, a vehicle is an example of a moving body and is not limited to vehicles. Moving bodies according to this specification may include various objects that can move, such as vehicles, people, bicycles, ships, trains, etc. Hereinafter, for convenience of explanation, cases where the moving body is a vehicle will be explained as examples.

Also, in this specification, a vehicle electronic device may be referred to by other names such as vehicle infrared (Infra-Red) camera, vehicle black box, car dash cam, or car video recorder.

Also, in this specification, a vehicle service system may include at least one vehicle-related service system among car black box service systems, advanced driver assistance systems (ADAS), traffic control systems, autonomous vehicle service systems, teleoperated driving systems, AI (Artificial Intelligence) vehicle control systems, and V2X service systems.

Referring to FIG. 1, the vehicle service system 1000 includes a vehicle electronic device 100, a vehicle service providing server 200, and a user terminal device 300. The vehicle electronic device 100 can wirelessly access wired/wireless communication networks and exchange data with the vehicle service providing server 200 and user terminal device 300 connected to wired/wireless communication networks.

The vehicle electronic device 100 can be controlled by user control input through the user terminal device 300. For example, when a user selects an executable object installed in the user terminal device 300, the vehicle electronic device 100 can perform operations corresponding to events generated by user input for that executable object. Here, the executable object can be a kind of application installed in the user terminal device 300 that can remotely control the vehicle electronic device 100.

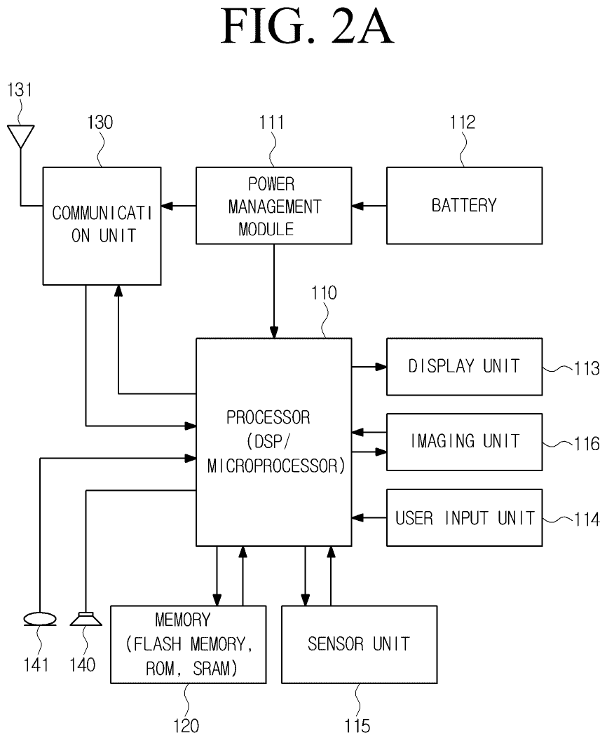

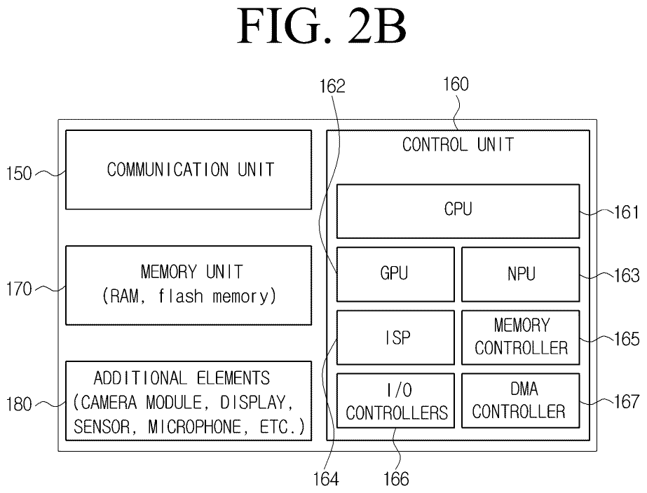

FIG. 2A is a diagram explaining a configuration example of a vehicle electronic device applicable to embodiments of this invention.

Referring to FIG. 2A, the vehicle electronic device 100 includes at least some of a processor 110, a power management module 111, a battery 112, a display unit 113, a user input unit 114, a sensor unit 115, an imaging unit 116, a memory 120, a communication unit 130, one or more antennas 131, a speaker 140, and a microphone 141.

The processor 110 controls the overall operation of the vehicle electronic device 100 and may be configured to implement the functions, procedures, and/or methods proposed in this specification. The processor 110 may include an application-specific integrated circuit (ASIC), other chipsets, logic circuits, and/or data processing devices. The processor may be an application processor (AP). The processor 110 may include at least one of a digital signal processor (DSP), central processing unit (CPU), graphics processing unit (GPU), and modem (modulator and demodulator).

The processor 110 may control all or part of the power management module 111, battery 112, display unit 113, user input unit 114, sensor unit 115, imaging unit 116, memory 120, communication unit 130, one or more antennas 131, speaker 140, and microphone 141. In particular, when various data is received through the communication unit 130, the processor 110 may control the display unit 113 to process the received data to generate a user interface and display the generated user interface. The processor 110 may be electrically or operably coupled with or connected to other components (for example, power management module 111, battery 112, display unit 113, user input unit 114, sensor unit 115, imaging unit 116, memory 120, communication unit 130, one or more antennas 131, speaker 140, and microphone 141) within the vehicle electronic device 100.

The processor 110 can perform signal processing functions to process image data acquired by the imaging unit 116 and image analysis functions to obtain information about on-site situations from images. For example, the signal processing functions include functions for compressing image data captured from the imaging unit 116 to reduce capacity. Image data has a form where multiple frames are collected along a time axis. In other words, it can be viewed as photographs continuously captured during a given time period. Since the capacity of such video is very large when uncompressed and storing it directly in memory would be very inefficient, compression is performed on digitally converted video. Video compression uses methods that utilize frame correlation, spatial correlation, and visual characteristics sensitive to low-frequency components. Since original data is lost due to compression, it can be compressed at an appropriate ratio to identify traffic accident situations of vehicles. For video compression, various video codecs such as H.264, MPEG4, H.263, H.265/HEVC can be used, and image data can be compressed using methods supported by the vehicle electronic device 100.

The image analysis functions can be based on deep learning and implemented through computer vision techniques. Specifically, the image analysis functions can include image segmentation functions that examine images by dividing them into multiple regions or segments, object detection functions that identify specific objects in images, advanced object detection models that recognize multiple objects in a single image (e.g., soccer field, forwards, defenders, soccer ball, etc.) (generating bounding boxes using XY coordinates and identifying everything within them), face recognition functions that not only recognize human faces in images but also identify individuals' identities, edge detection functions used to identify outer boundaries of objects or scenes to more accurately understand image content, pattern detection functions that recognize repeating shapes, colors, or other visual indicators in images, and feature matching functions that classify images by comparing their similarities.

These image analysis functions may be performed by the processor 110 of the vehicle electronic device 100, or they may be performed by the vehicle service providing server 200.

The power management module 111 manages power for the processor 110 and/or communication unit 130. The battery 112 supplies power to the power management module 111.

The display unit 113 outputs the results processed by the processor 110.

The display unit 113 can output content, data, or signals. In various embodiments, the display unit 113 can display image signals processed by the processor 110. For example, the display unit 113 can display captured or still images. In another example, the display unit 113 can display videos or camera preview images. In yet another example, the display unit 113 can display a graphical user interface (GUI) that enables interaction with the vehicle electronic device 100. The display unit 113 may include at least one of a liquid crystal display (LCD), thin film transistor-liquid crystal display, organic light-emitting diode (OLED), flexible display, or 3D display. The display unit 113 may be configured as an integrated touch screen by being combined with sensors capable of receiving touch input, etc.

The user input unit 114 receives input to be used by the processor 110. The user input unit 114 may be displayed on the display unit 113. The user input unit 114 can detect touch or hovering input from fingers and pens. The user input unit 114 can detect input caused by rotatable structures or physical buttons. The user input unit 114 may include sensors for detecting various types of inputs. Inputs received by the user input unit 114 may have various types. For example, inputs received by the user input unit 114 may include touch and release, drag and drop, long touch, force touch, physical depression, etc. The input unit 430 can provide received input and data related to received input to the control unit 450. In various embodiments, the user input unit 114 may include a microphone (or transducer) capable of receiving user voice commands. In various embodiments, the user input unit 114 may include an image sensor or camera capable of receiving user motions.

The sensor unit 115 includes one or more sensors. The sensor unit 115 has functions to detect impacts applied to the vehicle or detect when acceleration changes exceed a certain amount. In some embodiments, the sensor unit 115 may be image sensors such as high dynamic range cameras. In some embodiments, the sensor unit 115 includes non-visual sensors. In some embodiments, the sensor unit 115 may include radar, LiDAR (Light Detection And Ranging), and/or ultrasonic sensors in addition to image sensors. In some embodiments, the sensor unit 115 may include acceleration sensors, geomagnetic sensors, etc., to detect impact or acceleration.

In various embodiments, the sensor unit 115 may be attached to different positions of the vehicle and/or oriented in one or more different directions. For example, the sensor unit 115 may be attached to the front, sides, rear, and/or roof of the vehicle in forward-facing, rear-facing, side-facing, etc. directions.

The imaging unit 116 can capture images during at least one of parking, stopping, and driving situations of the vehicle. Here, the captured images may include parking lot images related to parking lots. Parking lot images may include images captured during the period from when the vehicle enters the parking lot until when the vehicle exits the parking lot. That is, parking lot images may include images captured from when the vehicle enters the parking lot until when the vehicle parks (e.g., until the vehicle engine is turned OFF for parking), images captured during the vehicle's parking period, and images captured from when parking is completed (e.g., when the engine is turned ON to exit) until when the vehicle exits the parking lot. Additionally, the captured images may include at least one of front, rear, side, and interior images of the vehicle. Also, the imaging unit 116 may include an infrared (Infra Red) camera capable of monitoring the driver's face or pupils.

Such imaging unit 116 may include a lens unit and an image sensor. The lens unit may perform the function of collecting optical signals, and the optical signals passing through the lens unit reach the imaging area of the image sensor to form an optical image. Here, the image sensor may use CCD (Charge Coupled Device), CIS (Complementary Metal Oxide Semiconductor Image Sensor), or high-speed image sensors that convert optical signals into electrical signals. Additionally, the imaging unit 116 may further include all or part of a lens unit drive, aperture, aperture drive, image sensor controller, and image processor.

The operating modes of the vehicle electronic device 100 may include continuous recording mode, event recording mode, manual recording mode, and parking recording mode.

The continuous recording mode is a mode that is executed when starting the vehicle's engine and beginning driving, and can maintain the continuous recording mode while the vehicle continues driving. In continuous recording mode, the vehicle image recording device 100 can perform recording in predetermined time units (for example, 1˜5 minutes). In this disclosure, continuous recording mode and normal mode may be used with the same meaning.

Parking recording mode refers to a mode that operates when the vehicle's engine is turned off or when battery power supply for vehicle driving is interrupted and the vehicle is in a parked state. In parking recording mode, the vehicle electronic device 100 can operate in parking continuous recording mode, which performs continuous recording during parking. Additionally, in parking recording mode, the vehicle electronic device 100 can operate in parking event recording mode, which performs recording when impact events are detected during parking. In this case, it can perform recording for a certain period from a predetermined time before until a predetermined time after the event occurs (for example, recording from 10 seconds before to 10 seconds after the event). In this specification, parking recording mode and parking mode may be used with the same meaning.

Event recording mode refers to a mode that operates when various events occur during vehicle driving.

Manual recording mode refers to a mode where recording is manually operated by the user. In manual recording mode, the vehicle electronic device 100 can perform recording for a period from a predetermined time before until a predetermined time after the user's manual recording request occurs (for example, recording from 10 seconds before to 10 seconds after the event).

The memory 120 is operably coupled with the processor 110 and stores various information for operating the processor 110. The memory 120 may include ROM (read-only memory), RAM (random access memory), flash memory, memory cards, storage media, and/or other storage devices. If implemented in software, the techniques described in this specification can be implemented as modules (for example, procedures, functions, etc.) that perform the functions described in this specification. The modules can be stored in memory 120 and executed by processor 110. The memory 120 can be implemented inside the processor 110. Alternatively, the memory 120 can be implemented outside the processor 110 and can be communicably connected to the processor 110 through various means known in the technical field.

The memory 120 may be configured internally to the vehicle electronic device 100, configured detachably through ports provided in the vehicle electronic device 100, or exist externally to the vehicle electronic device 100. When memory 120 is configured internally to the vehicle electronic device 100, it can exist in the form of hard disk drives or flash memory. When memory 120 is configured detachably to the vehicle electronic device 100, it can exist in the form of SD cards, Micro SD cards, USB memory, etc. When memory 120 is configured externally to the vehicle electronic device 100, it can exist in storage space on other devices or database servers through the communication unit 130.

The communication unit 130 is operably coupled with the processor 110 and transmits and/or receives wireless signals. The communication unit 130 includes a transmitter and a receiver. The communication unit 130 may include baseband circuitry for processing radio frequency signals. The communication unit 130 controls one or more antennas 131 to transmit and/or receive wireless signals. The communication unit 130 can enable the vehicle electronic device 100 to communicate with other devices, and here, the communication unit 130 may be provided as at least one combination of various known communication modules such as cellular-based mobile communication modules, Wireless LAN (Local Area Network) modules like near-field wireless communication modules, communication modules using Low-Power Wide-Area (LPWA) technology, etc. Additionally, the communication unit 130 can also perform location tracking functions like a GPS (Global Positioning System) Tracker.

The speaker 140 outputs sound-related results processed by the processor 110. For example, the speaker 140 can output audio data indicating that a parking event has occurred. The microphone 141 receives sound-related input to be used by the processor 110. The received sounds can help recognize the situation at the time, along with images captured by the imaging unit 116, such as sounds from external impacts or human voices related to situations inside/outside the vehicle. Sounds received through the microphone 141 can be stored in the memory 120.

FIG. 2B is a diagram explaining another example of the vehicle electronic device 100 according to an embodiment of this invention.

Referring to FIG. 2B, the vehicle electronic device 100 may include a communication unit 150, a control unit 160 (which may be referred to as a ‘processor’), a memory unit 170, and additional elements 180.

The communication unit 150 can perform communication by transmitting and receiving wireless signals with external entities. In particular, it can transmit the vehicle's location to external entities in real-time or transmit image data collected by the vehicle electronic device 100 to external entities. The communication unit 150 may be operably coupled with the control unit 160. The communication unit 150 may include baseband circuitry for processing radio frequency signals. The communication unit 150 may control one or more antennas (not shown) to transmit and/or receive wireless signals. The communication unit 130 may be provided as at least one combination of various known communication modules such as cellular-based mobile communication modules, Wireless LAN (Local Area Network) modules like near-field wireless communication modules, communication modules using Low-Power Wide-Area (LPWA) technology, etc. Additionally, the communication unit 150 may also perform location tracking functions like a GPS (Global Positioning System) tracker.

The control unit 160 can perform overall operations of the vehicle electronic device 100 and control components of the vehicle electronic device 100. The control unit 160 can be configured in the form of a single chip, such as a System-On-Chip (SoC), that includes various functions. Accordingly, the control unit 160 configured as an SoC may include CPU 161, GPU 162, NPU (Neural Processing Unit) 163, ISP (Image Signal Processor) 164, Memory Controller 165, I/O Controllers 166, DMA Controller (Direct Memory Access Controller) 167, etc. This is one example of the control unit 160's configuration by SoC, and the components of the control unit 160 can be added or modified. For example, inside the control unit 160, a small amount of memory (not shown) such as CPU 161's cache memory or system ROM (Read Only Memory) is included. Additionally, the communication unit 150 may be included as a component within the control unit 160.

The CPU 161 processes general computations and commands related to the operation or control of the vehicle electronic device 100. The GPU 162 performs computations related to graphics to provide smooth and clear graphic representation on high-resolution displays and performs operations related to image processing and rendering. The NPU 163 can perform computations for learning artificial intelligence/machine learning (Artificial Intelligence/Machine Learning: AI/ML) to accelerate and efficiently process artificial neural network computations. Accordingly, it can perform operations using artificial intelligence/machine learning (AI/ML) in Advanced Driver-Assistance Systems (ADAS) operations.

While FIG. 2B shows NPU 163 included in the control unit 160 for AI computation acceleration, the GPU 162 could also process AI computations instead of NPU 163.

The ISP 164 can convert raw image data input from camera modules into digital images through signal processing. The memory controller 165 manages data exchange between the control unit 160 and external memory 170 (RAM, flash memory, etc.).

The I/O Controllers 166 manage interfaces with various input/output devices equipped in the vehicle electronic device 100, such as USB (Universal Serial Bus) or SD (Secure Digital Card) card slots, and the DMA Controller 167 enables data transfer between memories without CPU 161 intervention.

The memory 170 can be configured with volatile storage devices such as RAM (Random Access Memory) or non-volatile storage devices such as flash memory. RAM serves as a temporary data storage, temporarily storing data that is generated or processed while the vehicle electronic device 100 is operating. For example, raw image data from the camera may be temporarily stored in RAM before or during processing.

Data can be stored semi-permanently in non-volatile storage devices. In vehicle electronic devices 100, SD cards or embedded flash memory are mainly used. Image data processed by the ISP (Image Signal Processor) 164 can be finally stored in this non-volatile memory.

The additional elements 180 may include camera modules, displays, sensors such as accelerometer sensors, microphones, etc. The camera module can capture images of the vehicle surroundings or vehicle interior. Generally, the camera module includes front and rear cameras. It may also include side cameras. Additionally, related to embodiments of this invention, the camera module includes an interior camera. The display can provide real-time images or stored images to users or provide menu settings. The accelerometer sensor detects vehicle movement and can specially protect video data at specific moments such as sudden braking or collisions. The microphone can record sounds inside or outside the vehicle.

The control unit 160 configured as SoC, memory 170, and additional elements 180 can be connected and operate as follows:

The camera module can convert light into digital signals and transmit them to ISP 164. The ISP 164 processes these signals to generate digital images, and the generated digital images can be further processed (e.g., compression, AI analysis, etc.) by GPU 162 or NPU 163. The CPU 161 can oversee these processes and control components through necessary commands. Additionally, video data generated through processing by ISP 164, GPU 162, or NPU 163 can be temporarily stored in RAM through the memory controller 165 or finally stored in memory 170 such as non-volatile memory. The I/O Controller 166 communicates with external interfaces (e.g., USB ports) to allow users to access video data, and the DMA Controller 167 can independently manage data transfer between memories to reduce CPU load.

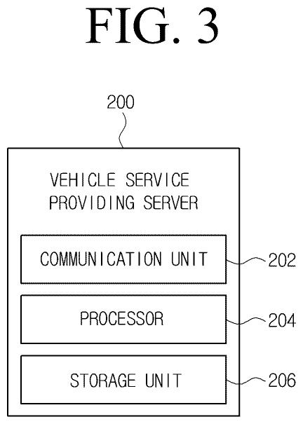

FIG. 3 is a diagram explaining the configuration of a vehicle service providing server applicable to embodiments of this invention.

Referring to FIG. 3, the vehicle service providing server 200 includes a communication unit 202, a processor 204, and a storage unit 206. The communication unit 202 of the vehicle service providing server 200 connects through wired/wireless communication networks with the vehicle electronic device 100 and/or user terminal device 300 to transmit and receive data.

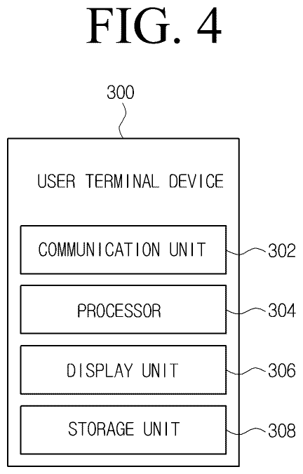

FIG. 4 is a diagram explaining the configuration of a user terminal device according to embodiments of this invention.

Referring to FIG. 4, the user terminal device 300 includes a communication unit 302, a processor 304, a display unit 306, and a storage unit 308. The communication unit 302 connects through wired/wireless communication networks with the vehicle electronic device 100 and/or vehicle service providing server 200 to transmit and receive data. The processor 304 controls overall functions of the user terminal device 300 and, according to embodiments of this specification, transmits commands input from users to the vehicle service system 1000 through the communication unit 302. When the processor 304 receives control messages related to vehicle service from the vehicle service providing server 200, it controls the display unit 306 to display them to the user.

In particular, the processor 304 can be configured, for example, in the form of a System On Chip (SoC). Accordingly, the processor 304 may include processors (not shown) such as CPU (Central Processor Unit), GPU (Graphic Processor Unit), NPU (Neural Processor Unit), ISP (Image Signal Processor), etc.

The CPU performs brain functions of the processor, processing operating system and various application tasks, maintaining performance and power efficiency, and controlling the operation of components of the user terminal device 300. The GPU handles computations related to 2D (Dimension) and 3D graphics to provide smooth and clear graphic representation on high-resolution displays. The NPU performs computations for AI and machine learning training to accelerate and efficiently process artificial neural network computations. The ISP, as an image signal processing device, converts analog signals input from image sensors into digital images and performs various image processing tasks.

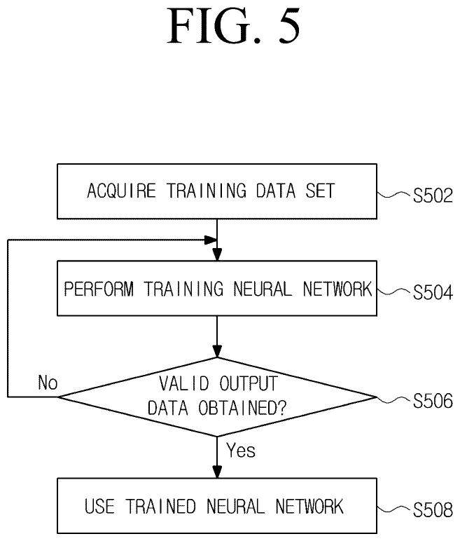

FIG. 5 is a diagram explaining the operation of an electronic device 600 training a neural network based on a set of training data according to embodiments of this invention.

Referring to FIG. 5, in operation S502, the electronic device 600 can acquire a set of training data. The electronic device 600 can acquire a set of training data for supervised learning. The training data may include pairs of input data and corresponding ground truth data. The ground truth data may represent output data intended to be obtained from the neural network that receives the input data that is paired with this ground truth data.

For example, when training a neural network for image recognition, the training data may include images and information about one or more subjects contained in those images. The information may include the classification (category or class) of subjects identifiable through the images. The information may include the location, width, height, and/or size of visual objects corresponding to subjects within the images. The set of training data identified through operation S502 may include multiple pairs of training data. Within the above example of training a neural network for image recognition, the set of training data identified by the electronic device 600 may include multiple images and ground truth data corresponding to each of these multiple images.

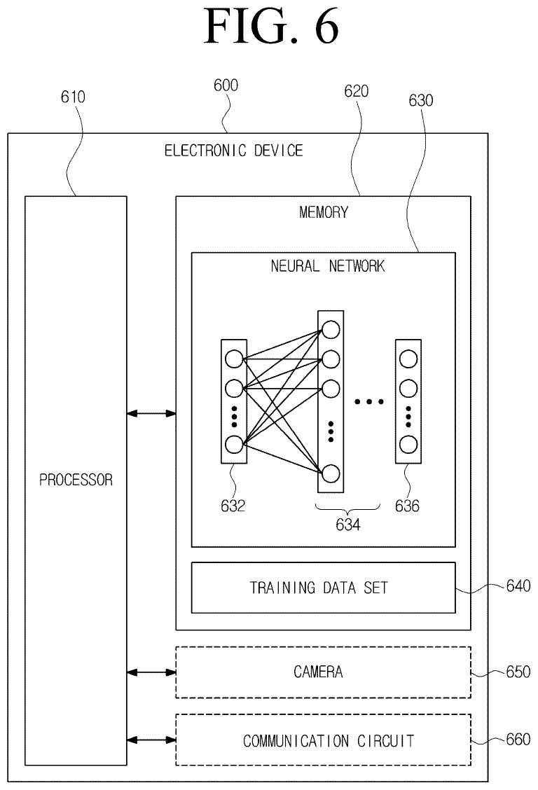

Referring again to FIG. 5, in operation S504, the electronic device 600 can perform training on the neural network based on the set of training data. In one embodiment where the neural network is trained based on supervised learning, the electronic device 600 can input the input data included in the training data to the input layer of the neural network. An example of the neural network including this input layer is explained with reference to FIG. 6. From the output layer of the neural network that received the input data through the input layer, the electronic device 600 can obtain output data from the neural network corresponding to the input data.

In one embodiment, the training in operation S504 can be performed based on the difference between the output data and the ground truth data included in the training data corresponding to the input data. For example, the electronic device 600 can adjust one or more parameters related to the neural network to reduce this difference based on the gradient descent algorithm. The operation of the electronic device 600 adjusting these one or more parameters may be referred to as tuning the neural network. The electronic device 600 can perform tuning of the neural network based on the output data using a function defined to evaluate the performance of the neural network, such as a cost function. The above-mentioned difference between output data and ground truth data can be included as an example of this cost function.

Referring again to FIG. 5, in operation S506, according to one embodiment, the electronic device 600 can identify whether valid output data is output from the neural network trained by operation S504. That output data is valid means that the difference between the output data and ground truth data (or cost function) satisfies conditions set for using the neural network. For example, when the average value and/or maximum value of the difference between output data and ground truth data is below a specified threshold, the electronic device can determine that valid output data is being output from the neural network.

If valid output data is not output from the neural network (S506—No), the electronic device 600 can repeatedly perform neural network training based on operation S504. The embodiment is not limited to this, and the electronic device 600 can repeatedly perform operations S502 and S504.

With valid output data obtained from the neural network (S506—Yes), based on operation S508, according to one embodiment, the electronic device 600 can use the trained neural network. For example, the electronic device 600 can input different input data, distinct from the input data that was input to the neural network as training data, into the neural network. The electronic device 600 can use the output data obtained from the neural network that received this different input data as the result of performing inference on this different input data based on the neural network.

FIG. 6 is a diagram explaining the configuration of electronic device 600 according to embodiments of this invention.

The electronic device 600 in FIG. 6 can be one of the vehicle electronic device 100 performing AI/ML operations, vehicle service providing server 200, or user terminal device 300 shown in FIG. 1.

Referring to FIG. 6, the processor 610 of the electronic device 600 can perform calculations related to the neural network 630 stored in memory 620. The processor 610 may include at least one of a CPU (center processing unit), GPU (graphic processing unit), or NPU (neural processing unit). The NPU can be implemented as a separate chip from the CPU, or can be integrated with the CPU on the same chip in the form of an SoC (system on a chip). The NPU integrated with the CPU can be referred to as a neural core and/or AI (artificial intelligence) accelerator.

Referring to FIG. 6, the processor 610 can identify the neural network 630 stored in memory 620. The neural network 630 can include a combination of input layer 632, one or more hidden layers 634 (or intermediate layers), and output layer 636. The aforementioned layers (e.g., input layer 632, one or more hidden layers 634, and output layer 636) can include multiple nodes. The number of hidden layers 634 can vary depending on the embodiment, and a neural network 630 including multiple hidden layers 634 can be referred to as a deep neural network. The operation of training this deep neural network can be referred to as deep learning.

In one embodiment, when neural network 630 has the structure of a feed forward neural network, a first node included in a specific layer can be connected to all second nodes included in another layer prior to that specific layer. Within memory 620, parameters stored for neural network 630 can include weights assigned to connections between the second nodes and the first node. In neural network 630 having the structure of a feed forward neural network, the value of the first node can correspond to the weighted sum of values assigned to the second nodes based on weights assigned to connections connecting the second nodes and the first node.

In one embodiment, when neural network 630 has the structure of a convolution neural network, a first node included in a specific layer can correspond to a weighted sum of some of the second nodes included in another layer prior to that specific layer. Some of the second nodes corresponding to the first node can be identified by a filter corresponding to that specific layer. Within memory 620, parameters stored for neural network 630 can include weights representing this filter. The filter can include one or more nodes to be used in calculating the weighted sum of the first node from among the second nodes, and weights corresponding to each of these one or more nodes.

According to one embodiment, the processor 610 of electronic device 600 can perform training on neural network 630 using the training data set 640 stored in memory 620. Based on training data set 640, processor 610 can adjust one or more parameters stored in memory 620 for neural network 630 by performing operations explained with reference to FIG. 5.

According to one embodiment, the processor 610 of electronic device 600 can perform object detection, object recognition, and/or object classification using neural network 630 trained based on training data set 640. Processor 610 can input images (or video) acquired through camera 650 to the input layer 632 of neural network 630. Based on the input layer 632 to which images are input, processor 610 can sequentially obtain values of nodes in layers included in neural network 630 to obtain a set of values (e.g., output data) of nodes in output layer 636. This output data can be used as the result of inferring information included in these images using neural network 630. The embodiment is not limited to this, and processor 610 can input images (or video) acquired from external electronic devices connected to electronic device 600 through communication circuit 660 to neural network 630.

In one embodiment, neural network 630 trained to process images can be used to identify regions corresponding to subjects within images (object detection), and/or identify the class of subjects represented in images (object recognition and/or object classification). For example, electronic device 600 can use neural network 630 to segment regions corresponding to subjects within images based on rectangular shapes like bounding boxes. For example, electronic device 600 can use neural network 630 to identify at least one class that matches the subject from among multiple designated classes.

The first embodiment below explains embodiments of this invention. The embodiments explained below can be implemented based on the devices or device components of FIGS. 1-6, functions, methods, and procedures explained in FIGS. 1-6.

### First Embodiment

The first embodiment of this invention relates to an electronic device and operating method of the electronic device that, when detecting external intrusion into a vehicle, or the presence of children or animals inside the vehicle using interior images of the vehicle acquired by a camera located inside the vehicle during parking (including cameras whose lens field of view can capture the vehicle interior), notifies the detected information to the user.

The electronic device according to the first embodiment can be an electronic device mounted in a vehicle or at least a part of the electronic device, and can include components of electronic devices 100, 600 described in FIGS. 1-6. For convenience of explanation, assume the electronic device according to the first embodiment is electronic device 600 of FIG. 6. In this case, electronic device 600 includes camera 650 configured to acquire interior images during vehicle parking, processor 610 configured to generate background images of the vehicle interior from the interior images and identify (or detect) moving objects in the vehicle using the background images and currently captured interior images, and communication circuit 660 configured to transmit information related to detected moving objects to the user's terminal directly or via a server when moving objects are detected in the vehicle interior.

The following describes each component of the electronic device according to the first embodiment in more detail.

Camera 650 of electronic device 600 can acquire interior images of the vehicle during parking.

Processor 610 of electronic device 600 checks if the vehicle is in parking mode, and if confirmed to be in parking mode, controls camera 650 to capture interior images for a predetermined time (e.g., 2 minutes) or at regular time intervals. At this time, to reduce power consumption of electronic device 600, processor 610 can control camera 650 to set the frame rate for image capture for vehicle interior monitoring to a preset value (e.g., 5 FPS (Frames Per Second)).

Meanwhile, processor 610 can use vehicle ignition state detection function and/or vehicle battery operation power state detection function to check the vehicle's parking mode. That is, processor 610 can check whether the vehicle is driving or parked/stopped based on factors like the vehicle battery voltage.

For example, processor 610 can set different battery voltages for distinguishing vehicle operation states (stopped state, parked state, driving state, etc.) according to the type of vehicle power transmission system.

Specifically, processor 610 can set different battery voltages for identifying vehicle operation states depending on whether the vehicle's power transmission system is an Internal Combustion Engine Vehicle (ICEV) receiving power from an internal combustion engine or an Electric Vehicle (EV) receiving operating power from a battery.

For example, if the vehicle is an ICEV, processor 610 can set battery voltages for engine-on and engine-off states as follows:
Engine-off state (V_{ignition_off})

The engine-off state is when only battery power is supplied to the vehicle, and in this case, according to embodiments of this invention, the battery voltage can be set to a value between 12.5V˜12.7V (first range).
Engine-on state (V_{ignition_on})

The engine-on state is when the generator (alternator) is charging the battery, and in this case, the generator can produce a voltage higher than the battery voltage to increase the battery voltage. According to embodiments of this invention, the battery voltage in this state can be set to a value between 13.8V˜14.4V (second range).

On the other hand, since an EV's electric motor is a device that rotates by receiving electricity from the battery, before operating power is supplied to the electric motor, the battery voltage can vary within a certain range depending on the charging state. For example, with a lithium-ion battery, when the charging state is 100%, the voltage is 4.2V, and when the charging state is 0%, the voltage can be 3.0V. And when operating power is supplied to the electric motor, the battery voltage can vary depending on the motor's resistance and load. Specifically, the motor's resistance varies with motor rotation speed or torque, with higher resistance meaning higher load and lower resistance meaning lower load, and higher load leading to lower battery voltage while lower load leads to higher battery voltage.

For example, when an EV accelerates or climbs slopes, the motor resistance is high and load is high so battery voltage decreases, and when the electric vehicle decelerates or drives on flat ground, the motor resistance is low and load is low so battery voltage increases. Since battery voltage changes affect battery performance and lifespan, a Battery Management System (BMS) (not shown) can monitor and regulate battery voltage. For example, in embodiments of this invention, processor 610 can identify EV operation state through battery voltage monitored by the BMS.

Specifically, in an EV, battery voltage can differ as follows between when operating power is supplied to the electric motor and before operating power is supplied to the electric motor (parked state, stopped state):
When operating power is supplied to electric motor (V_{EM_On})

When operating power is supplied to the electric motor, the electric motor rotates using battery power which can put load on the battery. Therefore, battery voltage after operating power is supplied to the electric motor becomes slightly lower than battery voltage before operating power is supplied. Generally, battery voltage when operating power is supplied to the electric motor is maintained between 13.5V˜14.1V (third range).
Before operating power is supplied to electric motor (parked state, stopped state) (V_{EM-Off})

When operating power is not supplied to the electric motor, the battery can be charged using power supplied from the generator (alternator) or external charging stations. At this time, the generator/external charging station can produce voltage higher than the battery voltage to increase battery voltage. Generally, battery voltage when operating power is not supplied to the electric motor is maintained between 14.1V˜14.5V (fourth range).

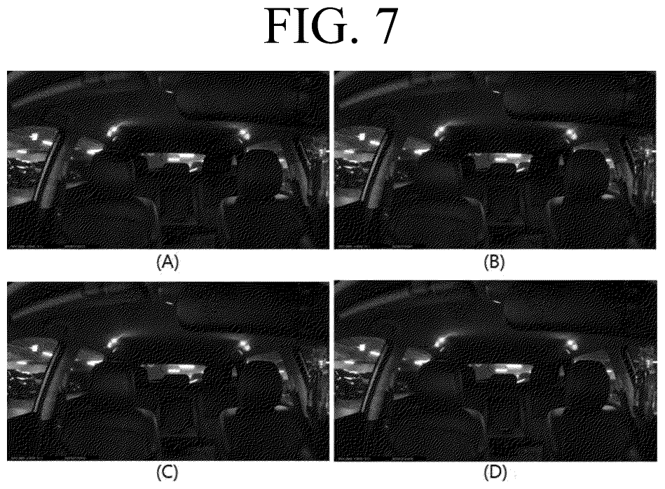

Therefore, as described above, for an ICEV, battery voltage is slightly lower than a certain threshold value (about 13V) in the engine-off state, and slightly higher than this certain threshold value (about 13V) in the engine-on state. In contrast, for an EV, battery voltage is lower than a certain threshold value (about 14.1V) when operating power is supplied to the electric motor, and higher than this certain threshold value (about 14.1V) when operating power is not supplied to the electric motor. However, battery voltage can vary depending on battery condition. For example, if the vehicle's battery is old or damaged, battery voltage may deviate from the normal range. Processor 610 can generate background images using vehicle images captured in parking mode identified based on measured vehicle battery voltage as described above. In particular, when generating background images, it can set Regions of Interest (ROI) to maximally exclude vehicle window areas for each of multiple interior images, and generate background images of the vehicle interior from the interior images with set ROIs. Additionally, processor 610 can generate background images using average values of interior images captured at regular intervals according to a certain frame rate during parking mode. The following FIGS. 7-10 explain examples of how background images (of the vehicle interior) are generated. Meanwhile, ‘background images’ may be referred to as ‘Reference Images (RI)’.

FIG. 7 is a diagram explaining examples of captured images according to the first embodiment of this invention.

Referring to FIG. 7, (a) to (d) are examples of interior images captured during 2 minutes after entering parking mode. Four images are shown as examples in FIG. 7. The time interval for capturing interior images in parking mode can vary according to settings. The time interval for capturing interior images can be set to one or more frames per second (i.e., 1 FPS or higher), typically within 10 FPS. For reference, the normal frame rate for video recording during vehicle driving is 30 FPS.

In one embodiment, processor 610 can set Regions of Interest (ROI) in each captured interior image (a) to (d). A Region of Interest refers to an area that is the target of interest for image processing. The Region of Interest can be part of the image or the entire image. When a Region of Interest is defined in the entire image, image processing algorithms can be applied to the selected Region of Interest. This can reduce computation time and memory usage during image processing. In one embodiment, the Region of Interest can be set to maximally exclude window areas from the entire image.

Since this embodiment is for detecting abnormal states inside the vehicle, movements outside the vehicle do not need to be detected. Therefore, processor 610 can improve image processing speed by excluding window areas that show external vehicle states from the Region of Interest. However, depending on the case, processor 610 can include window areas in the Region of Interest. Below explains examples of how processor 610 sets Regions of Interest.

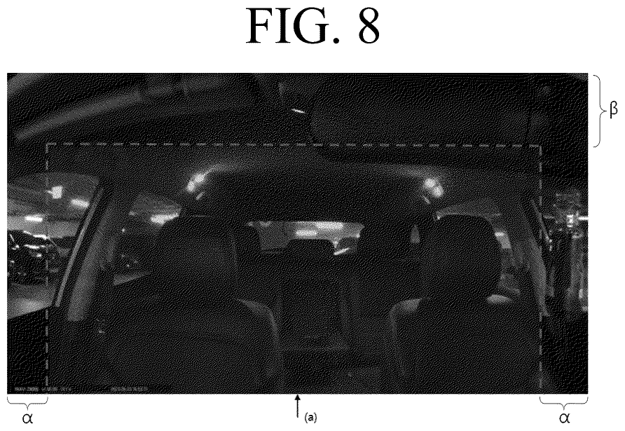

FIG. 8 is a diagram explaining an example of setting a Region of Interest according to the first embodiment of this invention.

Referring to FIG. 8, in one embodiment, when setting the Region of Interest, processor 610 can exclude a certain ratio (=first ratio) (a) from both left and right based on the bottom center point (a) of the interior image, and also exclude a certain ratio (=second ratio) (B) from the top. In FIG. 8, an example is shown where 10% (α=0.1) of the image is excluded from both left and right based on the bottom center point (a), and 20% (β=0.2) of the image is excluded from the top. The ratio excluded from the background image when setting the Region of Interest (hereinafter may be referred to as ‘image exclusion ratio’) can vary according to preset settings. According to this method, the Region of Interest is shown as the area within the dotted lines in FIG. 8.

For the Region of Interest to be set according to preset image exclusion ratios, the installation position of camera 650 inside the vehicle must be fixed to a specific position. The above image exclusion ratios are set assuming camera 650 is installed in this specific position. If camera 650 is installed in a different position than this specific position, the captured background image will be different. If the background image is different, the image exclusion ratio for setting the Region of Interest may need to be different. Therefore, a camera installation guide should be provided to users (or camera installers) so that camera 650's installation position inside the vehicle remains consistent. Meanwhile, in one embodiment, the image exclusion ratio can also be set in real-time from the background image using machine learning or deep learning models. In this case, camera 650's installation position may not need to be fixed to a specific position. Regions of Interest can be set for each of the interior images in FIG. 7 according to the above method. Hereinafter, images with set Regions of Interest may be referred to as ‘Region of Interest images’ or ‘ROI images’.

Once Region of Interest images are generated, processor 610 can generate background images using the generated Region of Interest images. Specifically, processor 610 can generate background images by combining Region of Interest images over a certain time period (e.g., 2 minutes) after entering parking mode. Typically, processor 610 can generate background images from interior images captured at one or more frames per second (i.e., 1 FPS or higher). Processor 610 can control electronic device 600 to operate in low power mode during parking mode, and can control camera 650 to operate at a frame rate of 10 FPS or lower in low power mode. Therefore, processor 610 can generate background images while minimizing power consumption of electronic device 600 by controlling camera 650 to operate at a low frame rate of 10 FPS or lower in parking mode.

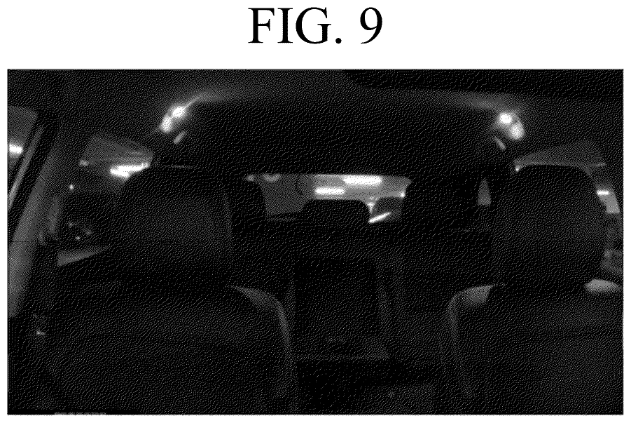

FIG. 9 is a diagram showing an example of a background image generated from Region of Interest images according to the first embodiment of this invention.

Referring to FIG. 9, according to one embodiment, the background image in FIG. 9 has a ratio regions excluded from both right and left sides of the interior image in FIG. 8, and B ratio region excluded from the top. As a result, most of the window areas on the right and left sides of the driver's seat are excluded from the background image in FIG. 9.

Meanwhile, in cases like dark parking lots where parking conditions are poor, the quality of interior images or Region of Interest images captured in parking mode may not be good. In such cases, when processor 610 generates background images by combining Region of Interest images, it can improve the quality of generated background images by removing noise using methods like histogram equalization.

Once background images are generated, processor 610 can detect (or identify) moving objects inside the vehicle using the generated background images. At this time, processor 610 can divide the current interior image into one or more regions and detect moving objects by each divided region. Meanwhile, when dividing the interior image, processor 610 can sequentially apply multiple split filters with different split sizes in ascending order by split size. This way, as the split size decreases, the size of one divided region in the entire current interior image can gradually become smaller. As one divided region sequentially becomes smaller like this, not only large moving objects but also small moving objects can be easily detected. Meanwhile, processor 610 can perform classification based on machine learning for moving objects, and based on the classification results, can acquire specific information about moving objects (e.g., person (adult, child, infant), dog, etc.) and notify this to users.

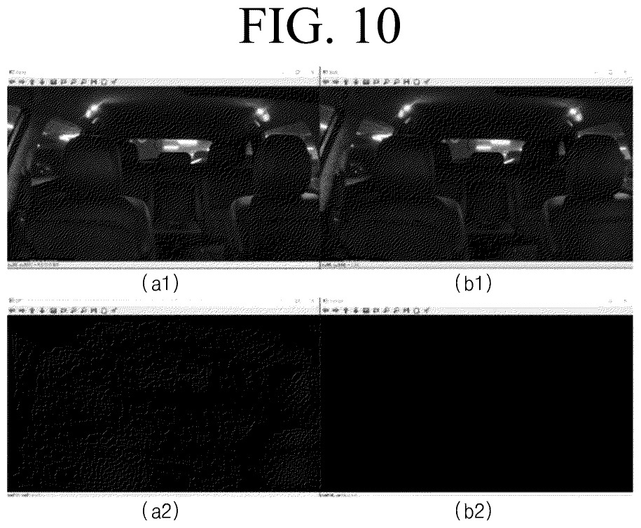

Below, referring to FIGS. 10-12, examples are explained of how processor 610 identifies and detects moving objects inside the vehicle using background images.

FIG. 10 is a diagram illustrating a case where no moving object exists in the vehicle when verifying moving objects in the vehicle based on the background image according to the first embodiment of this invention.

Referring to FIGS. 10, (a1) and (b1) are “current interior images” captured in chronological order to detect moving objects inside the vehicle after the background image was generated. (a2) and (b2) show graphical processing of difference values between the current interior images in (a1) and (b1) and the background image generated in FIG. 9. Areas with no difference between current interior image and background image are shown in black, while areas with differences are shown in white. The fact that (a2) and (b2) are both shown in black means there is no difference between the current interior images in (a1) and (b1) and the background image in FIG. 8. In other words, (a2) and (b2) indicate that no moving objects were detected in the current images (a1) and (b1).

In this specification, “moving object detection” means detecting moving objects inside the vehicle, which can be used interchangeably with “object movement detection” in the sense of detecting object movement.

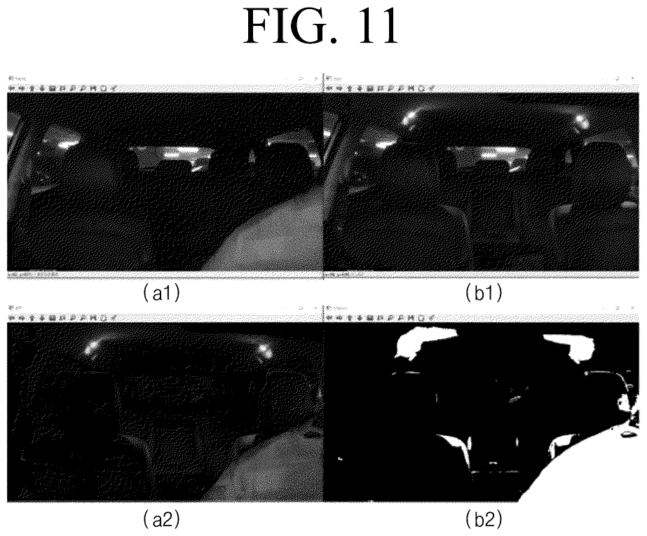

FIG. 11 is a diagram illustrating a case where a moving object exists in the vehicle when verifying moving objects in the vehicle based on the background image according to the first embodiment of this invention.

Referring to FIGS. 11, (a1) and (b1) are “current interior images” captured in chronological order to detect moving objects inside the vehicle after the background image was generated. (a2) and (b2) show graphical processing of difference values between the current interior images in (a1) and (b1) and the background image generated in FIG. 9. The appearance of white areas in (a2) and (b2) means there are differences between the current interior images (a1) and (b1) and the background image in FIG. 8. In other words, (a2) and (b2) indicate that moving objects exist in the current interior images (a1) and (b1).

Meanwhile, in one embodiment, processor 610 can detect moving objects by dividing the current interior image region and detecting moving objects by each divided region. Below explains an example of detecting moving objects by dividing the current interior image region. Meanwhile, since the current interior image is compared with the background image to determine whether moving objects exist in the current interior image in this invention's embodiment, the current interior image may be referred to as a ‘Target Image’. Also, as mentioned above, the background image may be referred to as a ‘Reference Image (RI)’.

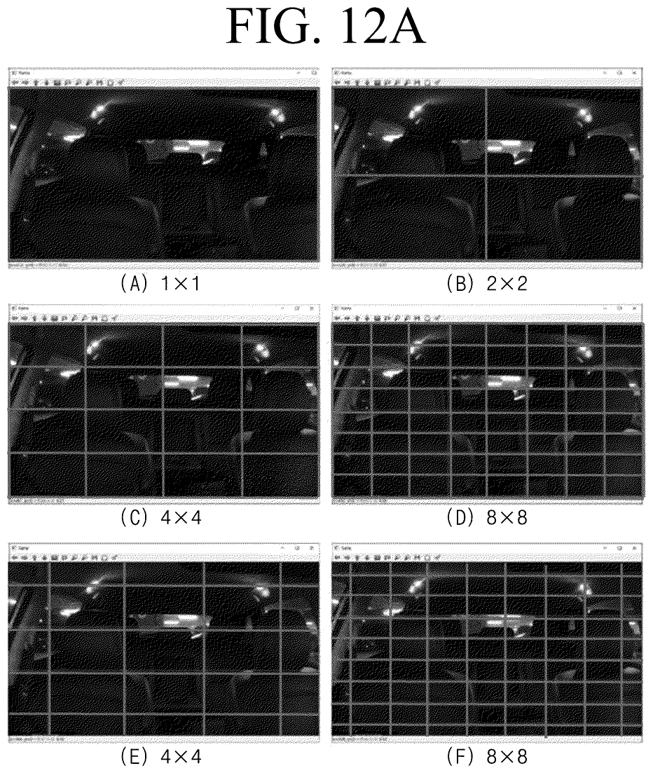

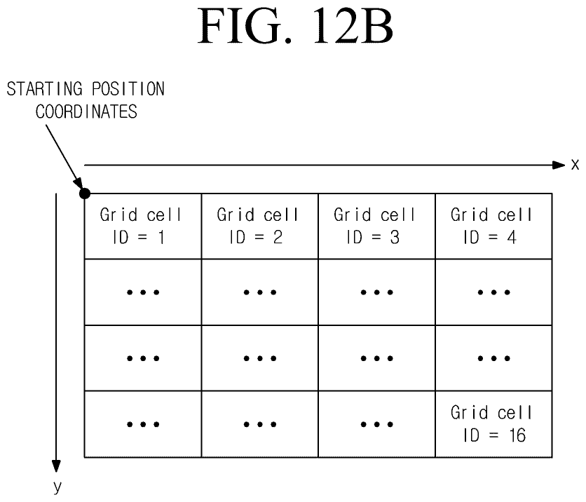

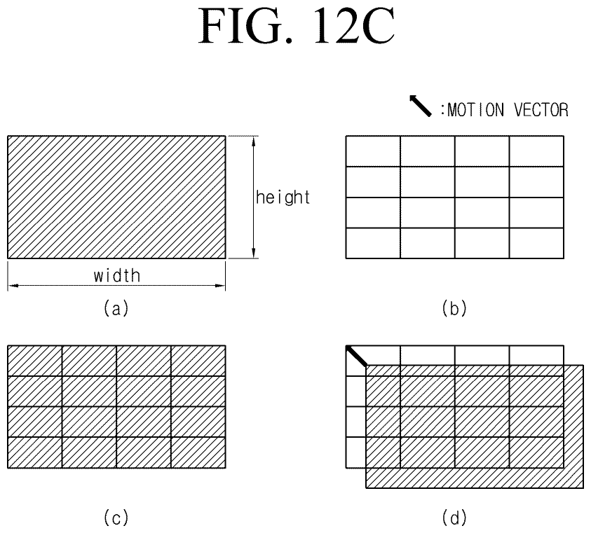

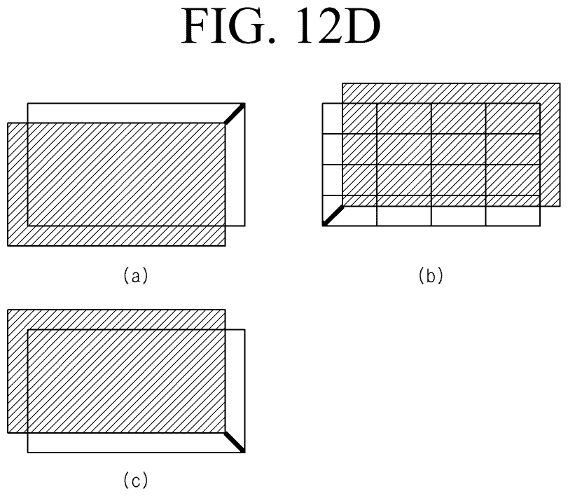

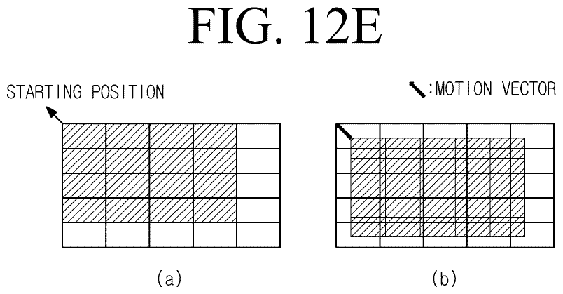

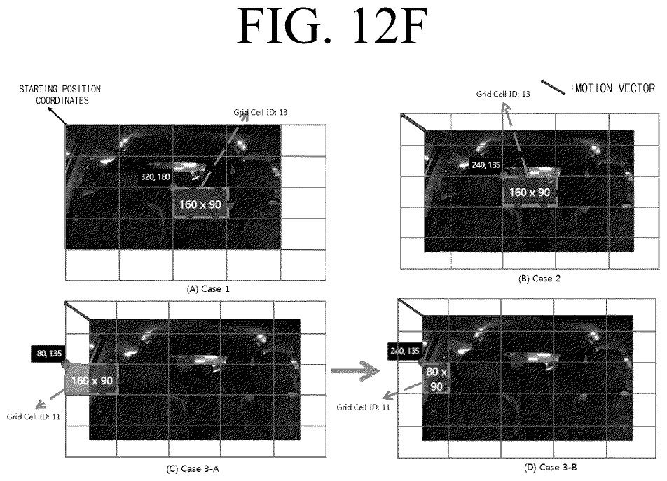

FIG. 12A is a diagram illustrating a case of detecting moving objects by displaying regions of the reference image in a grid pattern and dividing into multiple grid cells according to the displayed grid pattern according to the first embodiment of this invention.

To explain the grid cells in FIG. 12A, let's first explain grid containers and grid cells with reference to FIG. 12B.

FIG. 12B is a diagram explaining the concept of grid containers and grid cells in the first embodiment of this invention.

In this invention, a frame that can cover one entire image frame is called a grid container, and each of the multiple cells of equal size that make up this one image frame grid container is called a grid cell. Since the grid container size needs to cover the target image, the grid container size can be either equal to or larger than the image size. Also, a grid cell refers to the smallest grid within the grids included in the grid container. That is, a grid cell is the minimum rectangular area created by four intersecting grid lines.

FIG. 12B shows an example where one grid container includes 16 grid cells. Grid cell identifiers (IDs) can be assigned to each grid cell, and FIG. 12B shows grid cell IDs assigned to each grid cell. Meanwhile, the division size of a grid container can be expressed as the number of areas divided in the X-axis and Y-axis directions. For example, in FIG. 12B, one grid container is divided into 4 areas in the X-axis direction and 4 areas in the Y-axis direction. In this case, the division size of that grid container becomes 4×4.

Referring back to FIG. 12A, (A) through (D) show examples of dividing the current interior image with grid containers of different division sizes but the same size.

That is, (A) is a grid container with division size 1×1, where one grid container is divided into one area each in X-axis and Y-axis directions. As a result, the 1×1 grid container includes a total of one grid cell. Therefore, when the 1×1 grid container is applied to the image, the image is not actually divided.
(B) is a grid container with division size 2×2, where one grid container is divided into 2 areas each in X-axis and Y-axis directions. As a result, grid container (B) includes a total of 4 grid cells, and the image is divided into 4 areas.
(C) is a grid container with division size 4×4, where one grid container is divided into 4 areas each in X-axis and Y-axis directions. As a result, grid container (C) includes a total of 16 grid cells, and the image is divided into 16 areas.
(D) is a grid container with division size 8×8, where one grid container is divided into 8 areas each in X-axis and Y-axis directions. As a result, grid container (D) includes a total of 64 grid cells, and the image is divided into 64 areas.

Meanwhile, (C) and (E), and (D) and (F) respectively show examples where grid containers have the same division size but different starting positions for the first grid cell in the upper left area of the grid container.

That is, (E) has a 4×4 grid container applied like (C). However, the starting position of the first grid cell in the upper left in (E) is set differently from the starting position of the first grid cell in the upper left in (C). Also, (F) has an 8×8 grid container applied like (D). However, the starting position of the first grid cell in the upper left in (F) is set differently from the starting position of the first grid cell in the upper left in (D). The specific method for setting different grid cell starting positions will be explained later.

Meanwhile, the reason for using multiple grid containers with the same division size but different grid cell starting positions, like (C) and (E) and (D) and (F), is as follows:

When moving objects are located on grid cell boundary lines, they may not be detected. Therefore, using multiple grid containers with the same division size but differently positioned grid cells allows better detection of moving objects. For example, when grid containers with division sizes of 4×4 or larger like (C) and (D) are applied to the target image, applying multiple grid containers with the same division size but different grid cell starting positions to that target image can further improve the detection rate of moving objects in that target image.

In one embodiment, processor 610 can detect moving objects by applying grid containers (A) through (F) to the current interior image in ascending order according to division size. That is, processor 610 can first detect moving objects in the entire target image using grid containers with small division sizes, i.e., 1×1 grid containers, and sequentially detect moving objects using grid containers with larger division sizes.

Processor 610 can detect moving objects using the 1×1 grid container of (A). That is, processor 610 applies the 1×1 grid container to both the target image (TI) and the reference image (RI) background image. Then, it calculates pixel values (Pixel_Value_RI_Fixed) within the total one grid cell in the target image, and calculates pixel values (Pixel_Value_RI_Fixed) within the total one grid cell in the reference image. Then, it calculates a first difference value (Differ_1) which is the difference between these calculated pixel values, and if this first difference value is larger than a preset threshold, it can determine that a moving object exists within the one grid cell in the target image. Moving object detection using the 1×1 grid container of (A) may be conveniently referred to as ‘Level 1 detection’. The threshold can be preset with various experimental values, and preferably can be set to “30”. This threshold can be applied equally to object detection at each level described below.

If no moving object is detected in Level 1 detection of (A), processor 610 can detect moving objects using the 2×2 grid container of (B). That is, processor 610 applies the 2×2 grid container to both the target image (TI) and the reference image (RI) background image. Then, it calculates pixel values (Pixel_Value_RI_Fixed) for each of the total 4 grid cells in the target image, and calculates pixel values (Pixel_Value_RI_Fixed) for each of the total 4 grid cells in the reference image. Then, it calculates a first difference value (Differ_1) which is the difference between the pixel values calculated for each grid cell, and if this first difference value is larger than the preset threshold, it can determine that a moving object exists within that grid cell in the target image. Moving object detection using the 2×2 grid container of (B) may be conveniently referred to as ‘Level 2 detection’.

If no moving object is detected in Level 2 detection of (B), processor 610 can perform ‘Level 3 detection’ for each grid cell using the 4×4 grid container of (C) in the same way as explained in (A) and (B), and if no moving object is detected in Level 3 detection of (C), processor 610 can perform ‘Level 4 detection’ using the 8×8 grid container of (D).

Meanwhile, at each of these levels, processor 610 can detect moving objects using multiple grid containers that have the same size but different grid cell positions. For example, in Level 3 detection above, both the 4×4 grid container of (C) and the 4×4 grid container of (E) can be used together, and in Level 4 detection, both the 8×8 grid container of (D) and the 8×8 grid container of (F) can be used together.

Using grid containers with sequentially larger division sizes (i.e., smaller grid cell sizes) to detect moving objects as described above is because the division size needed for detecting moving objects can vary depending on the size of the moving objects. That is, if the moving object is very large, it can be detected even using grid container (A) with large grid cell sizes like 1×1. On the other hand, if the moving object is small, grid containers with smaller grid cell sizes may be needed. Accordingly, processor 610 can efficiently detect various sizes of moving objects by applying grid containers with different division sizes to the target image.

So far, we've explained an embodiment where grid containers with different division sizes are applied in ascending order of division size to detect moving objects, and when a moving object is detected using a grid container of that division size, detection at the next level is not performed.

In another embodiment, processor 610 can perform detection at next levels (e.g., Level 3 and Level 4) even when moving objects are detected at a lower level (e.g., Level 2). That is, even if large moving objects are detected at a lower level, processor 610 can perform detection at next levels to detect small moving objects.

In another embodiment, processor 610 can apply grid containers with different division sizes in descending order according to division size, and stop moving object detection when a moving object is detected using a grid container of that size.

In another embodiment, processor 610 can apply grid containers with different division sizes in descending order according to division size, and detect moving objects using grid containers at the next level even when moving objects are detected using grid containers of that size.

When moving objects are detected inside the vehicle according to the above embodiments, processor 610 can classify the detected moving objects. For this, processor 610 can crop the grid cell area determined to contain objects in the target image and classify moving objects in the cropped grid cell image. For example, the processor can input the cropped image area to a Machine Learning Model, and the Machine Learning Model can classify the class of moving objects existing in the input image area. At this time, classes classified by the machine learning model can include pre-learned types of objects such as children, adults, pets, etc.

Subsequently, processor 610 can notify information about the detected moving objects to the user's terminal. This moving object information can include notification information that moving objects were detected and/or class information about the detected moving objects.

Below, grid containers with the same division size but different grid cell starting positions are explained in more detail with reference to FIG. 12C.

FIG. 12C is a diagram explaining a case where grid containers have the same division size but different grid cell starting positions according to the first embodiment of this invention.

Referring to FIG. 12C, (a) is an arbitrary image with a certain width and height, and (b) is a 4×4 grid container with the same size as image (a).
(c) shows the state where grid container (b) is exactly mapped to image (a). At this time, the position of the grid container is fixed.
(d) shows the state where the grid container has moved from state (c) by the direction and magnitude of the motion vector. In (d), the motion vector's direction is upper left, and the motion vector's magnitude is exemplified as ½ of the diagonal length of one grid cell.

Earlier in FIG. 12A, (E) and (F) were explained as having the same grid container division sizes as (C) and (D) respectively, but different grid cell starting positions. In this invention's embodiment, grid containers with the same division size but different grid cell starting positions can be set using this method where grid containers move according to the direction and magnitude of motion vectors. Meanwhile, in this invention's embodiment, the direction and magnitude of motion vectors can have various variations according to preset settings.

FIG. 12D shows various examples of motion vectors according to the first embodiment of this invention.

In case (a), the motion vector's direction is upper right, and its magnitude is ½ of the diagonal length of one grid cell. Accordingly, it shows the state where the grid container has moved according to the motion vector's direction and magnitude.

In case (b), the motion vector's direction is lower left, and its magnitude is ½ of the diagonal length of one grid cell. Accordingly, it shows the state where the grid container has moved according to the motion vector's direction and magnitude.

In case (c), the motion vector's direction is lower right, and its magnitude is ½ of the diagonal length of one grid cell. Accordingly, it shows the state where the grid container has moved according to the motion vector's direction and magnitude.

Combining (d) from FIG. 12C and (a), (b), (c) from FIG. 12D, in this invention's embodiment, motion vector directions are exemplified as upper left, upper right, lower left, and upper left, and the motion vector's magnitude is exemplified as ½ of the diagonal length of one grid cell. However, motion vector directions and magnitudes can be set to different directions (e.g., right direction, left direction, upward, downward) and various magnitudes (e.g., ¼, ¾ etc. of the grid cell) than those exemplified.

The grid containers explained in FIGS. 12C and 12D are set to have sizes identical to the image size. However, in this case, when grid containers move according to motion vectors as in (d) of FIG. 12C and (a), (b), (c) of FIG. 12D, areas appear where the grid container does not cover the image. To compensate for this issue, grid containers larger than the image size can be used.

That is, in cases like (d) of FIG. 12C and (a), (b), (c) of FIG. 12D, when a 4×4 grid container with the same size as the image is used, when the grid container moves according to the motion vector, a problem occurs where there are areas of the image not covered by the amount the moved grid container has shifted. To solve this problem in this invention's embodiment, a 5×5 grid container with grid cells added in both horizontal and vertical directions compared to the 4×4 grid container can be used. That is, one row and one column can be added to the 4×4 grid container.

FIG. 12E is a diagram explaining an example of using a grid container larger than the image considering cases where the grid container moves according to motion vectors according to the first embodiment of this invention.
(a) shows an example where a 5×5 grid container larger than the image is used. That is, if no motion vector is set to move the grid container (or if the motion vector is “0”), there is no need to move the grid container, so as explained in FIGS. 12C and 12D, the grid container size can be the same as the image size and the processor according to this invention's embodiment can easily detect moving objects. However, as in (a) of FIG. 12E, in this invention's embodiment, considering that the grid container will move according to motion vectors, grid containers larger than the image size can also be used.
(b) shows the state where grid container (a) has moved according to the motion vector. Because a 5×5 grid container larger than the image size was used, even after the grid container has moved according to the motion vector, the grid container can cover all areas of the image.

Below explains examples of how grid cell coordinates are set.

FIG. 12F is a diagram explaining various examples of how grid cell coordinates are set according to the first embodiment of this invention.
(A) is Case 1, showing an example of how grid cell coordinates are set when the grid container's starting position is aligned with the upper left of the target image. (B) is Case 2, showing an example of how coordinates are set for grid cells not located at the edges of the grid container when the grid container has moved according to the motion vector. (C) and (D) are Case 3, showing examples of how coordinates are set for grid cells located at the edges of the grid container when the grid container has moved according to the motion vector.

In each case of FIG. 12F, one grid cell size is 160×90 and the motion vector is assumed to be (−80, −45). Below explains each case:
Case 1: (A) shows an example where a 5×5 grid container larger than the target image is applied to the target image, and at this time, the grid container's starting position is set to align with the upper left of the target image. In (A), the grid container's starting position and coordinates become (0,0). For example, the grid cell with Grid Cell ID 13 has starting coordinates of (320, 180) and becomes an area with size 160×90.
Case 2: (B) shows the state where the grid container from (A) has moved according to the motion vector. Since the motion vector is (−80,−45), in (B) the coordinates of each grid cell's starting position move 80 to the left and 45 upward. Accordingly, in (B), the grid cell with Grid Cell ID 13 has starting coordinates of (240, 135) and becomes an area with size 160×90. This grid cell with Grid Cell ID 13 is a grid cell not located at the edge of the grid container.
Case 3: (C) shows the state where the 5×5 grid container has moved according to the motion vector as in (B). Since the motion vector is (−80,−45), in (C) the coordinates of each grid cell's starting position move 80 to the left and 45 upward. At this time, the grid cell with Grid Cell ID 11 is a grid cell located at the left edge of the grid container. The grid cell with Grid Cell ID 11 should be set as an area with starting coordinates (−80,135) and size 160×90. However, there is no image data in negative coordinate areas. Therefore, as with grid cells located at grid container edges like in (C), when starting coordinates would be set to negative values according to the motion vector, it is not appropriate to set those grid cell coordinates by directly applying the motion vector magnitude. Therefore, for grid cells located at grid container edges like this, their coordinates are set according to (D).

Referring to (D), the starting coordinates for the grid cell with Grid Cell ID 11 become (0,135) rather than (−80,135). Also, the size of the grid cell with Grid Cell ID 11 becomes 80×90 rather than 160×90. Therefore, the grid cell with Grid Cell ID 11 becomes an area with starting coordinates (0,135) and size 80×90.

Below explains the operation of electronic devices for detecting objects inside vehicles according to this invention's embodiment.

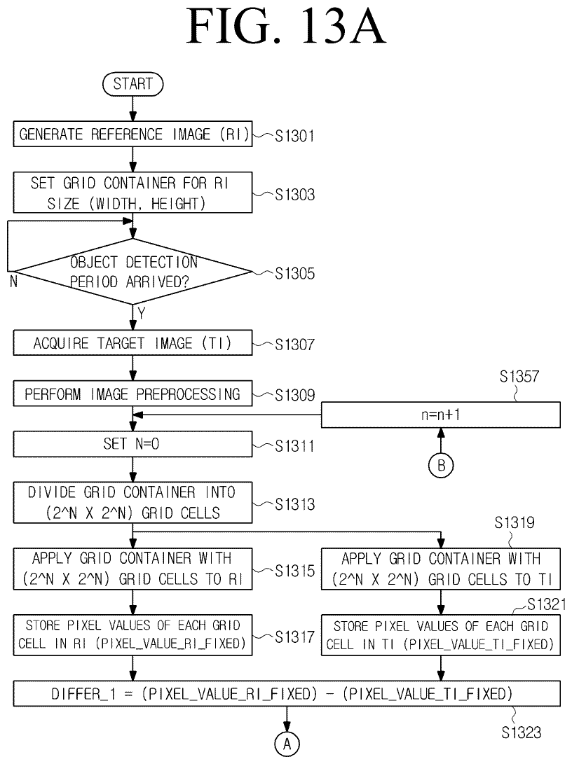

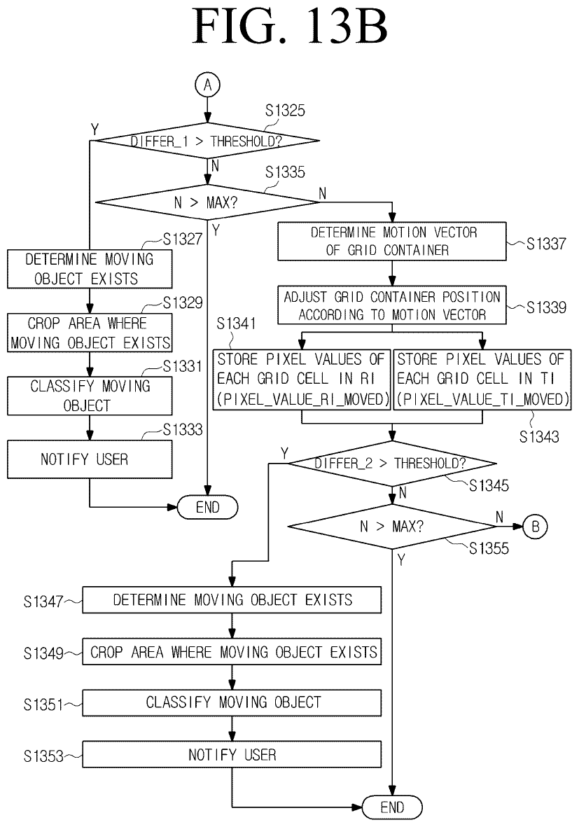

FIG. 13A and FIG. 13B are diagrams explaining the operation of an electronic device according to the first embodiment of this invention.

Referring to FIGS. 13A and 13B, the electronic device generates a background image using vehicle interior images. This background image may be referred to as Reference image: RI in step S1301.

The reference image can be generated using at least one vehicle interior image over a certain time period (e.g., 2 minutes). The interior images can be acquired through capture by the electronic device's interior camera. Additionally, the interior images can be captured when the vehicle is in parking mode. The electronic device can confirm vehicle parking mode by detecting the vehicle's ignition state. Meanwhile, the frame rate for interior image capture can be a preset value (e.g., 5FPS) lower than the frame rate for video recording mode (=30FPS).

The electronic device can identify the size values (width, height) of the reference image and set grid containers to be applied to the reference image with the identified size values in step S1303. Here, the size of grid containers to be applied to the reference image can either match the reference image size, or the size of grid containers to be applied to the reference image can be one grid cell larger in width and height than the reference image size. For example, as explained in FIG. 12E, if the grid container moves according to motion vectors, a grid container one grid cell larger in width and height than the reference image size can be set, and if motion vectors are not considered, a grid container with the same size as the reference image can be set.

The electronic device checks whether a preset object detection period T has arrived in step S1305, and if the detection period has arrived, proceeds to the next step to acquire a target image of the vehicle interior in step S1307. Here, the object detection period T can be the period for acquiring image frames to detect moving objects inside the vehicle at predetermined time intervals.

The electronic device can perform image preprocessing on the acquired target image in step S1309. This image preprocessing can include, for example, gray conversion, brightness correction, and noise removal through Gaussian filtering.

The gray conversion converts color images to grayscale images. Since grayscale images are easier to process than color images, gray conversion can be performed when necessary.

The noise removal is to improve the quality of background images generated by improving the quality of interior images. For noise removal, methods like histogram equalization can be utilized as one example. For reference, histogram equalization is a technique that improves image contrast by “equalizing” the image histogram. When an image's histogram (e.g., brightness) is skewed to one side, the entire image may be too dark or too bright, causing loss of image detail, but histogram equalization can solve this problem by redistributing the skewed histogram to improve image quality.

Meanwhile, the electronic device sets n to 0 in step S1311. Here, “n” is a division variable that determines the division size of grid containers. The electronic device divides grid containers into 2ⁿ×2ⁿ grid cells according to n in step S1313. For example, if n=0, the electronic device divides into 2⁰×2⁰=1×1 grid cells, if n=1, the electronic device divides into 2¹×2¹=2×2=4 grid cells, if n=2, the electronic device divides into 2²×2²=4×4=16 grid cells, and if n=3, the electronic device divides into 2³×2³=8×8=64 grid cells.

Subsequently, the electronic device applies the grid container with 2ⁿ×2ⁿ divided grid cells to RI in step S1315, and stores the pixel values (Pixel_Value_RI_Fixed) within each grid cell in RI in step S1317. Here, the pixel values can be RGB values (R=2⁸, G=2⁸, B=2⁸) or intensity values of pixels within each grid cell.

Additionally, the electronic device applies the grid container with 2\hat{ }n\hat{ }×2\hat{ }n\hat{ } divided grid cells to TI (S1319), and stores the pixel values (Pixel_Value_TI_Fixed) within each grid cell in TI (S1321). Here, the pixel values can be RGB values (R=2⁸, G=2⁸, B=2⁸) or intensity values of pixels within each grid cell.

Subsequently, the electronic device calculates the first difference value Differ_1 between the pixel values (Pixel_Value_RI_Fixed) within each grid cell in RI and the pixel values (Pixel_Value_TI_Fixed) within each grid cell in TI in step S1323.

The electronic device compares the first difference value Differ_1 calculated in step S1323 with a predetermined threshold value, and if the first difference value Differ_1 is larger than the threshold (in step S1325—Y), the electronic device can determine that pixel value changes have occurred due to object movement in the vehicle interior cabin room. That is, the electronic device determines that a moving object exists in the vehicle interior in step S1327.

The electronic device can crop the area where object movement was identified in TI in step S1329. At this time, the electronic device can identify the grid cell ID corresponding to the area where the degree of pixel value change is larger than the threshold and crop the image area determined to contain objects in the target image.

The electronic device can classify moving objects existing within the cropped image area in step S1331. For example, the electronic device can input the cropped image area to a Machine Learning Model, and the Machine Learning Model can classify the class of moving objects existing in the input image area. At this time, classes classified by the machine learning model can include pre-learned types of objects such as children, adults, pets, etc.

Subsequently, the electronic device can notify the object information identified in step S1331 to the user S1333. At this time, the object information can include information that moving objects exist in the vehicle and/or class information about the identified objects.

Meanwhile, if the first difference value Differ_1 is not larger than the threshold at step S1325 S1325—N, the electronic device determines whether n is larger than a preset maximum value Max in step S1335. If n is larger than the maximum value, it terminates operation without performing any further actions, and if n is not larger than the maximum value, it proceeds to step S1337.

The electronic device can determine the motion vector for the grid container. Here, the motion vector includes the direction and distance of grid container movement in step S1337. The electronic device adjusts the position of the grid container according to the determined motion vector in step S1339, stores pixel values (Pixel_Value_RI_Moved) within each grid cell in RI in step S1341, and stores pixel values (Pixel_Value_TI_Moved) within each grid cell in TI in step S1343. Here, pixel values can be RGB values or intensity values of pixels within each grid cell.

Subsequently, the electronic device calculates the second difference value Differ_2 between the pixel values (Pixel_Value_RI_Moved) within each grid cell in RI and the pixel values (Pixel_Value_TI_Moved) within each grid cell in TI, and compares the calculated second difference value Differ_2 with a predetermined threshold value in step S1345.

Based on the comparison result in step S1345, if the second difference value is larger than the threshold (in step S1345—Y), the electronic device can determine that pixel value changes have occurred due to object movement in the vehicle interior cabin room. That is, the electronic device determines that a moving object exists in the vehicle interior in step S1347.

The electronic device can crop the area where object movement was identified in TI in step S1349. At this time, the electronic device can identify the grid cell ID corresponding to the area where the degree of pixel value change is larger than the threshold and crop the grid cell area determined to contain objects in the target image.

The electronic device can classify moving objects existing within the cropped image area in step S1351. Specifically, for example, the electronic device can input the cropped image area to a Machine Learning Model, and the Machine Learning Model can classify the class of moving objects existing in the input image area. At this time, classes classified by the machine learning model can include pre-learned types of objects such as children, adults, pets, etc.

Subsequently, the electronic device can notify the object information identified in step S1351 to the user S1353. At this time, the object information can include information that moving objects exist in the vehicle and/or class information about the identified objects.

Meanwhile, if the second difference value Differ_2 is not larger than the threshold at step S1345 S1345-N, the electronic device determines whether n is larger than a preset maximum value Max in step S1355. If n is larger than the maximum value, it terminates operation without performing any further actions, and if n is not larger than the maximum value, it proceeds to step S1357 to increase n by 1 (n=n+1), and repeats operations from step S1311.

Meanwhile, the electronic device according to this invention can be an electronic device mounted in a vehicle, but generally, electronic devices mounted in vehicles often have lower hardware specifications compared to general user terminals like smartphones and laptops. Low-specification electronic devices often include only CPU without GPU or NPU, unlike recent user terminals, so they may not be able to classify moving object classes using machine learning models. Therefore, in this case, the electronic device can notify the user terminal that moving objects have been detected in the form of an alarm.

On the other hand, electronic devices capable of classifying moving object classes can classify moving object classes using machine learning models. The electronic device can transmit information about moving objects acquired according to classification results to the user terminal. This moving object information can include class information about moving objects (e.g., person (adult, child, infant), dog, etc.). Meanwhile, this moving object class information can take the form of at least one of text, image, or video information.

The alarm indicating that moving objects have been detected, or the moving object information can be transmitted to the user terminal using wireless/wired communication networks. Additionally, the alarm or moving object information can be transmitted to the user terminal via a server or directly to the user terminal without going through a server.

Below explains the electronic device's operations related to moving object class classification using machine learning and moving object information.

When moving objects are detected inside the vehicle, processor 610 can enter surveillance mode from parking mode and increase the frame rate for image recording. For example, if the frame rate in parking mode is 5FPS, processor 610 can change the frame rate to 30FPS for video recording of identified moving objects in surveillance mode.

Meanwhile, processor 610 can perform classification of the corresponding moving object based on the captured moving object's image (or cropped image) using machine learning algorithms such as Support Vector Machine (SVM). For reference, the SVM model is one of the supervised learning models in machine learning and is widely used for classification or regression analysis problems.

Processor 610 can acquire class information (person, dog, cat, etc.) according to the classification results and transmit the acquired information to the user terminal through communication circuit 660.

To perform image classification using machine learning, it is preferable for the vehicle's electronic device to be equipped with a Neural Processing Unit (NPU) or Graphics Processing Unit (GPU). However, since image classification requires less computational power compared to image detection, NPU or GPU may not be strictly necessary. Therefore, simple algorithm-based image classification can be performed even on general-purpose CPU (Central Processing Unit) without NPU or GPU.

Meanwhile, in the case of electronic devices inside vehicles, they are generally low-specification devices. Therefore, even for electronic devices capable of class classification using machine learning, the number of classes may be limited to a certain extent. For example, the number of moving object classes can be limited to around 10, such as people, dogs, cats, and other objects that could exist inside vehicles. Meanwhile, when the classification results show that the moving object is a person, it becomes important information whether that person is an adult, child, or baby.

Therefore, when the moving object class is a person, age group information can be additionally classified.

In one embodiment, processor 610 can classify the age group of that person using the ratio between the size of objects inside the vehicle and the size of the moving object person in the current interior image where the moving object was detected. If electronic device 600 is equipped with NPU or GPU, processor 610 can increase the number of classes and control NPU or GPU operation to determine the person's age group. On the other hand, if electronic device 600 is not equipped with NPU or GPU, processor 610 can limit the number of classes to a low threshold, or not determine the person's age group.

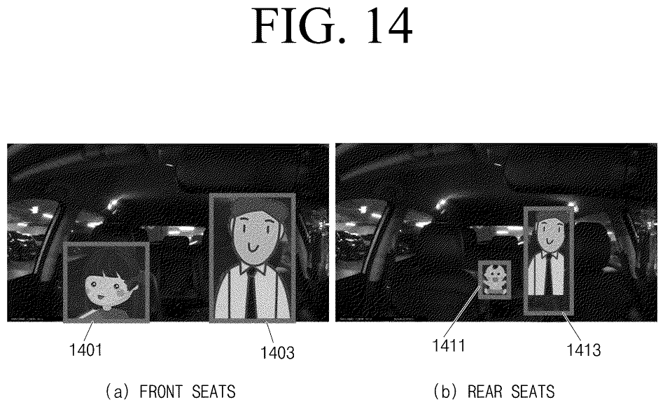

FIG. 14 is a diagram explaining an example of classifying the age group of a person who is a moving object according to the first embodiment of this invention.

Referring to FIG. 14, (a) shows an example where moving objects that are people are identified in two front seats. Based on the size and/or ratio within the entire image of rectangles 1401, 1403 containing the moving objects in the front seats, each moving object can be classified as a child and an adult respectively using machine learning.

(b) shows an example where moving objects that are people are identified in the back seats. Based on the size and/or ratio within the entire image of rectangles 1411, 1413 containing the moving objects in the back seats, each moving object can be classified as an infant and an adult respectively using machine learning.

### Second Embodiment

The second embodiment of the present invention relates to a driver monitoring system and method for implementing the same, which monitors driver behavior such as drowsy driving and forward gaze negligence using an interior camera mounted in a vehicle cabin during vehicle operation.

The second embodiment of the present invention discloses a method and system for monitoring a driver using a camera installed in a vehicle cabin with a viewing angle directed toward the driver to prevent drowsy driving during vehicle operation.

Recently, automobile companies have been installing various electronic devices in vehicles to improve driver convenience and safety. One of these is the Driver Monitoring System (DMS). DMS detects and analyzes the driver's behavior and condition in real-time, primarily used to enhance the safety of vehicles during operation. DMS operates using various sensors and cameras. Generally, a DMS-dedicated camera tracks the driver's face and detects eye movement, blinking frequency, and other features. Based on this information, DMS can determine if the driver is in a drowsy state or in other dangerous situations.

However, existing DMS requires the installation of a dedicated camera during vehicle manufacturing. Therefore, it is difficult to install DMS additionally in vehicles that are not equipped with DMS.

The second embodiment of the present invention proposes a DMS using a camera installed in the vehicle interior according to user needs after vehicle delivery. This enables the configuration of DMS using a camera installed by the user in the vehicle's passenger room or cabin room based on their needs, rather than a DMS-dedicated camera installed by the vehicle manufacturer before delivery. Accordingly, even after vehicle delivery by the manufacturer, DMS can be easily configured simply by installing a camera in the vehicle interior according to user needs.

The electronic device according to the second embodiment may be an electronic device installed in a vehicle or at least a part of an electronic device, and may include the components of the electronic device (100, 600) described in FIGS. 1 to 6. For convenience of explanation, it is assumed that the electronic device according to the second embodiment is the electronic device (600) of FIG. 6. In this case, the electronic device (600) includes a camera (650) configured to capture front images and driver images during vehicle operation, and a processor (610) configured to monitor the driver's condition in the vehicle using these images and provide warning messages to the driver when determining forward gaze negligence and/or drowsy driving based on the monitoring results. Meanwhile, the camera (650) may include a front camera and an interior camera, and the interior camera may have a viewing angle opposite to that of the front camera looking at the vehicle's front.

In the second embodiment of the present invention, the electronic device (600) acquires the mounting angle of the interior camera. The mounting angle can be acquired from front images captured by the front camera or using a gyro sensor that may be equipped in the electronic device. Additionally, the electronic device (600) detects feature points of the driver's face in the interior image captured by the interior camera. Subsequently, the driver's condition can be determined using the relative distances between the detected feature points. Specifically, the electronic device (600) can determine the driver's gaze direction and/or drowsy state using the relative distances between these feature points. If forward gaze negligence and/or drowsy state is determined, the electronic device (600) can provide a warning to the driver.

Meanwhile, the interior camera is typically not positioned directly in front of the driver. Therefore, the distances between feature points detected in the image captured by the interior camera may not match the actual distances on the driver's face. To correct this error, the electronic device uses the mounting angle of the interior camera. Specifically, the electronic device transforms the coordinates of the detected feature points into coordinates in the frontal coordinate system (=coordinate system of an image captured by the interior camera directly from the front of the driver's face) using the interior camera's mounting angle. Subsequently, the electronic device can determine the driver's gaze direction and/or drowsy state using the distances between feature points transformed to coordinates in the frontal coordinate system.

Based on the above description, the second embodiment of the present invention will be explained in detail below.

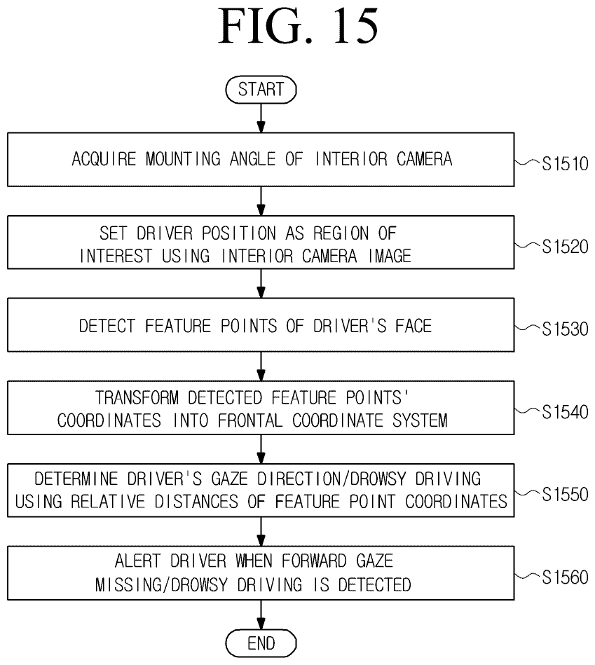

FIG. 15 is a diagram explaining the operation method of an electronic device 600 for DMS according to the second embodiment of the present invention.

Referring to FIG. 15, the processor (610) can acquire the mounting angle of the interior camera configured for capturing the vehicle interior (S1510).

As one method of acquiring the interior camera's mounting angle, the front camera can be used. Specifically, the processor (610) can detect straight lanes on the road from the front image captured by the front camera, determine the vanishing point of the straight lanes, and estimate the mounting angle of the front camera using the determined vanishing point of the straight lanes. Meanwhile, since the interior camera is positioned on the opposite side (i.e., rotated 180 degrees) of the front camera, the processor (610) can acquire the mounting angle of the interior camera using the mounting angle of the front camera.

As another method of acquiring the interior camera's mounting angle, a gyro sensor that may be equipped in the electronic device (600) can be used. Additionally, the processor (610) can acquire the interior camera's mounting angle using a weighted sum of the values obtained by these two methods.

Meanwhile, the processor 610 can set a region of interest where the driver is located in the interior image captured by the interior camera (S1520). Subsequently, the processor 610 can detect feature points of the driver's face within the region of interest (S1530).

The processor 610 can transform the coordinates of the detected feature points into coordinates in the frontal coordinate system using the mounting angle of the interior camera (S1540). Subsequently, the processor 610 can determine the driver's gaze direction and/or drowsy driving state using the relative distances between the coordinates of the feature points in the frontal coordinate system (S1550).

When the driver's state is determined to be forward gaze negligence and/or drowsy driving, the processor 610 can provide warning messages to the driver through sound or other means (S1560).

The operations of each step described above are explained below. Although these operations may be performed by the processor 610, they may be expressed as being performed by the electronic device for convenience.

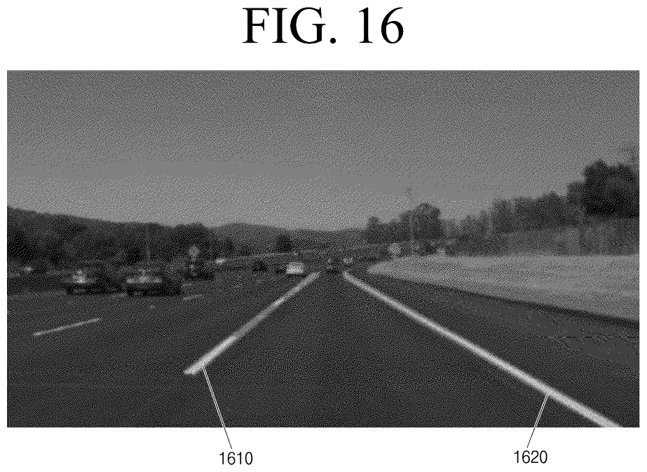

First, the operation of acquiring the mounting angle of the interior camera (S1510) is explained. As mentioned above, the mounting angle of the interior camera can be acquired using the front image or using a gyro sensor. Referring to FIGS. 16 to 19, the method of acquiring the mounting angle of the front camera from the front camera's front image and subsequently acquiring the mounting angle of the interior camera is explained.

FIG. 16 is a diagram explaining an example of the electronic device detecting straight lanes using a front image in the second embodiment of the present invention.

Referring to FIG. 16, straight lanes 1610, 1620 on the road can be detected by performing simple image processing (such as Edge detection) on the front image captured by the front camera of the electronic device. Straight lanes can be more easily detected in straight road sections. Therefore, the electronic device can determine whether the road where the vehicle is currently traveling is a straight road section using sensors such as GPS and/or navigation information, and can be configured to start detecting straight lanes when determined to be a straight road section. For example, the electronic device can determine that the current driving road is a straight road using latitude and longitude information obtained from GPS coordinates when the current vehicle speed is 50 km/h or higher.

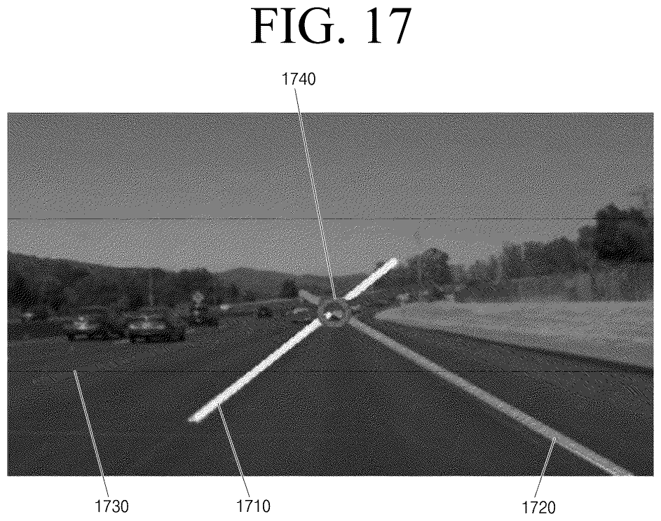

FIG. 17 is a diagram explaining an example of how the electronic device determines the vanishing point of straight lane lines according to the second embodiment of the present invention.

Referring to FIG. 17, the electronic device can determine intersection points by connecting the detected straight lines 1710, 1720, 1730 in the front image. The electronic device can accumulate these intersection points for a certain period and determine the vanishing point 1740 as the average value of the intersection points accumulated during this period.

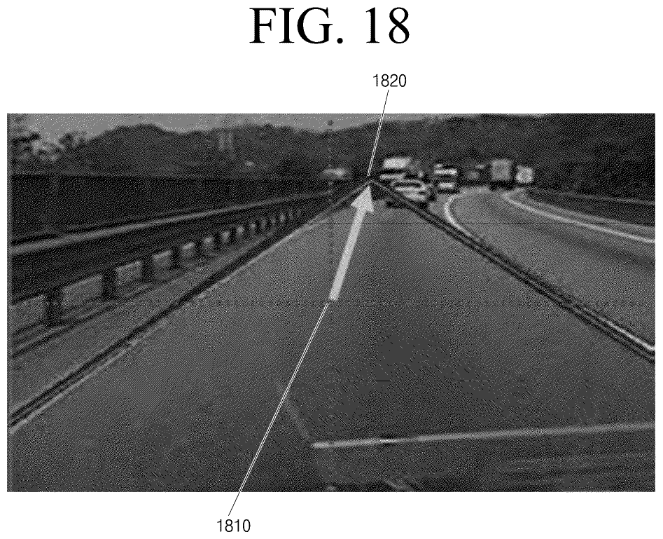

FIG. 18 is a diagram explaining how the electronic device estimates the mounting angle of the front camera from the vanishing point in the second embodiment of the present invention.

Referring to FIG. 18, the electronic device can estimate the mounting angle of the front camera from the coordinate difference between the center point 1810 of the front image captured by the front camera and the vanishing point 1820 determined in FIG. 17. As shown in the example of FIG. 18, the center point 1810 of the front image is located below and to the left of the vanishing point 1820. This means that, relative to the plane of the front image, the front camera is mounted tilted downward and to the left. In this way, the electronic device can estimate the mounting angle of the front camera from the difference in coordinate values between the center point 1810 and the vanishing point 1820.

The mounting angle of the front camera can consist of roll, pitch, and yaw components. Roll, yaw, and pitch are concepts used to describe the movement of aircraft, used to indicate the angle and direction of the aircraft.

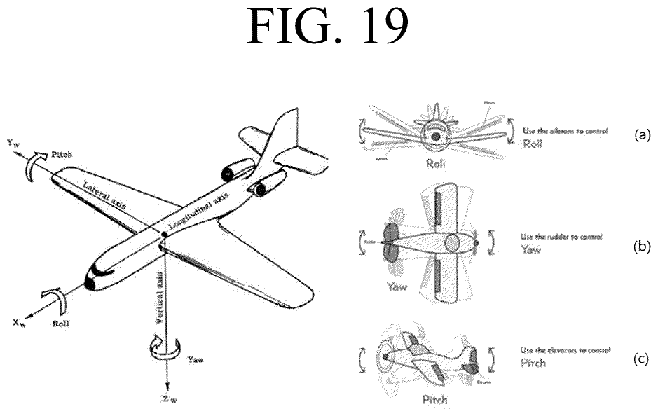

FIG. 19 is a diagram explaining the concepts of roll, yaw, and pitch in the second embodiment of the present invention.

Referring to FIG. 19, (a) Roll represents the movement of rotation around the lateral axis (x-axis) of the aircraft. An aircraft making a roll movement means it is tilting left/right around the lateral axis. A positive roll value indicates a right tilt state, and a negative roll value indicates a left tilt state.
(b) Pitch represents the movement of rotation around the horizontal axis (y-axis). An aircraft making a pitch movement means it is rotating left/right around the horizontal axis. A positive pitch value indicates clockwise rotation, and a negative pitch value indicates counterclockwise rotation.
(c) Yaw represents the movement of rotation around the vertical axis (z-axis). An aircraft making a yaw movement means it is moving forward/backward or ascending/descending around the vertical axis. A positive yaw value indicates the aircraft is ascending, and a negative yaw value indicates it is descending.

In the present embodiment, since the electronic device is installed in the ceiling of a moving vehicle, the movement of the electronic device can have characteristics similar to aircraft movement. Therefore, the mounting angle of the front camera can be expressed in terms of roll, pitch, and yaw components. As described above, the roll, pitch, and yaw representing the mounting angle of the front camera can be determined from the difference in coordinate values between the center point 1810 and the vanishing point 1820 shown in FIG. 18.

As explained in FIGS. 16 to 19, the electronic device can estimate the mounting angle of the front camera using the front image. The interior camera is installed 180 degrees opposite to the front camera. Therefore, the mounting angle of the interior camera can be easily acquired from the mounting angle of the front camera.

As another method of estimating the interior camera's mounting angle, when the electronic device is equipped with a gyro sensor, the electronic device can also estimate the mounting angle of the front camera using the gyro sensor. However, during vehicle operation, errors may occur in the gyro sensor measurements.

Therefore, the electronic device can also estimate the front camera's mounting angle as a weighted sum of the interior camera's mounting angle estimated using the front image and the interior camera's mounting angle estimated using the gyro sensor. In electronic devices without a gyro sensor, the method using the front image can be used.

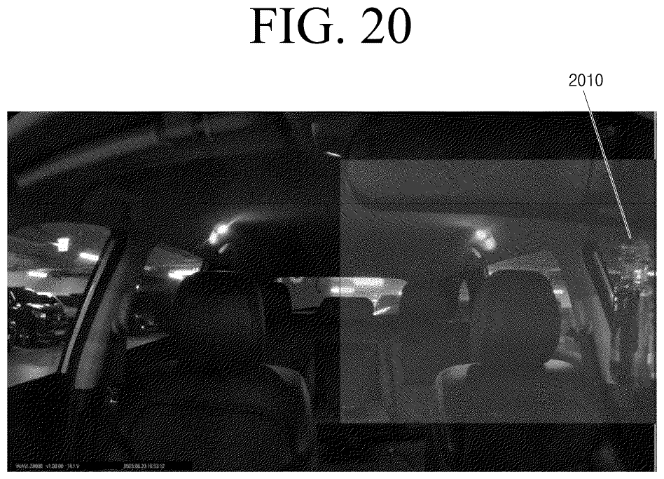

So far, the method of estimating the mounting angle of the interior camera has been explained. Below, referring to FIGS. 20 to 24, examples are explained of operations where a region of interest where the driver is located is set in step 1520 using the interior camera of the electronic device, feature points of the driver's face are detected in the region of interest in step 1530, the coordinates of the detected feature points are transformed into coordinates in the frontal coordinate system in step 1540, and the driver's state is monitored using the relative distances between coordinate values in step 1550.

FIG. 20 is a diagram explaining an example of setting a region of interest where the driver is located in an interior image according to the second embodiment of the present invention.

Referring to FIG. 20, a region of interest 2010 where the driver is located can be determined in the vehicle interior image. The region of interest can be determined from the position of the driver's seat. The driver's seat position can be preset to either left or right according to the country-specific driver's seat position. Therefore, the region of interest can be determined reflecting the preset driver's seat position.

Once the region of interest is set, the electronic device can detect feature points of the driver's face in the region of interest. The electronic device can detect feature points within a predetermined number of facial ranges considering hardware specifications or performance.

As a first method, the electronic device can detect one feature point from one feature portion such as eyes, nose, and mouth on the driver's face. This method may be suitable for electronic devices with lower hardware specifications.

As a second method, the electronic device can set the entire driver's face as a whole feature portion, set eyes, nose, and mouth as sub-feature portions respectively, and detect multiple feature points from both the whole feature portion and each detailed feature portion. The number of feature points can be changed according to settings. In this method, the overall contour and detailed contours of the face can be displayed using the feature points. This method may be suitable for electronic devices with higher hardware specifications. However, the first method can also be used in high-specification electronic devices.

Additionally, the first and second methods can be mixed. For example, the second method can be used for eyes, while the first method can be used for nose and mouth.

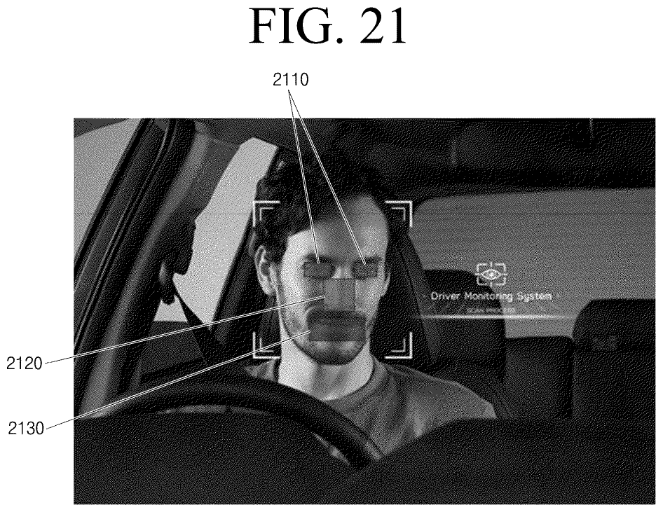

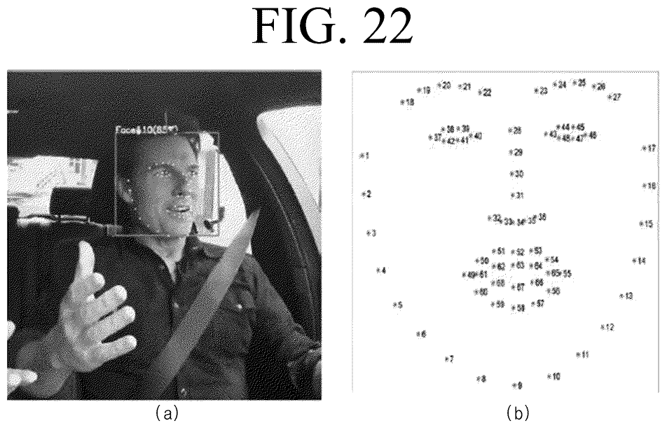

FIG. 21 is a diagram explaining an example of detecting a single feature point from a characteristic part of the driver's face in the second embodiment of the present invention, and FIG. 22 is a diagram explaining an example of detecting multiple feature points from a single characteristic part of the driver's face according to the second embodiment of the present invention.

Referring to FIG. 21, one feature part such as eyes 2110, nose 2120, and mouth 2130 of the driver's face can become one feature point. The electronic device can set each feature part on the face and, for example, detect the center point of each feature part as a feature point. That is, the electronic device can set rectangles of predetermined size for each of the eyes 2110, nose 2120, and mouth 2130, and detect the center point of the rectangle as a feature point.

Referring to FIG. 22, (a) shows an example where multiple feature points are detected from the entire driver's face and each of the eyes, nose, mouth, and eyebrows, and (b) shows a predetermined number (e.g., 68) of feature points detected in (a). Through the detected feature points, the contour lines of eyes and eyebrows, nose, mouth, and face are displayed.

Meanwhile, the electronic device can determine the driver's gaze direction and/or drowsy driving state using the distances between the feature points detected in FIG. 21 or FIG. 22. However, these feature points are detected from the image captured using the interior camera of the electronic device. Unlike typical DMS systems, the interior camera mounted in the vehicle according to the present embodiment may not be mounted directly in front of the driver's face. Generally, in countries like the United States, Korea, and China where the driver's seat is located on the left side of the vehicle, the interior camera installed inside the vehicle may be installed in the upper right relative to the driver to secure a wider viewing angle for monitoring the entire vehicle interior (in countries like the UK and Japan, the interior camera would be installed in the upper left of the driver). The distances between feature points detected in the driver's image captured from this position may not match the actual distances on the driver's face.

For example, in an image captured by the interior camera located at the front right of the driver, the relative distance from the center point of the driver's nose to the tip of the right ear in the image coordinates is shorter than the actual relative distance from the center of the nose to the tip of the right ear. That is, because the interior camera's position is not directly in front of the driver's face, the coordinates of feature points detected in the driver's image captured by the interior camera may not match the coordinates on the driver's actual face.

To correct this coordinate error, the electronic device transforms the coordinates of the detected feature points into coordinates in the frontal coordinate system. The frontal coordinate system can be defined as the coordinate system of an image captured by the camera from directly in front of the center point of the driver's face.

In the present embodiment, the electronic device can transform the coordinates of feature points detected in the interior image into coordinates in the frontal coordinate system using the previously acquired mounting angle of the interior camera.

The electronic device can determine the driver's gaze direction and/or drowsy driving state using the relative distances between the coordinates of feature points in the frontal coordinate system.

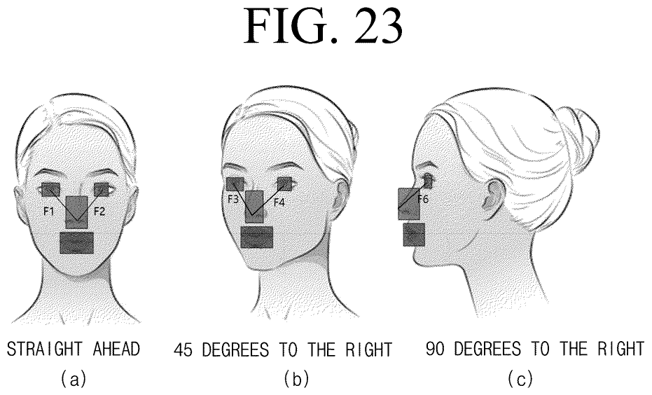

FIG. 23 is a diagram explaining an example of determining the driver's gaze direction using the feature point detected in FIG. 21 according to the second embodiment of the present invention.

Referring to FIG. 23, this figure illustrates examples of relative distances between feature points according to the rotation angle of the face when feature portions themselves (eyes, nose, mouth) are detected as single feature points as in FIG. 21.
(a) shows when the driver's face is facing straight ahead from the driver's seat, (b) shows when the driver's face is turned 45 degrees to the right from straight ahead from the driver's seat, and (c) shows when the driver's face is turned 90 degrees to the right from straight ahead. The electronic device can determine the driver's gaze direction in each case as follows:

In case (a), let F1 be the distance between the x-coordinate of the left eye center and the x-coordinate of the nose center, and F2 be the distance between the x-coordinate of the right eye center and the x-coordinate of the nose center. The electronic device calculates the ratio between F1 and F2. Since the driver is looking straight ahead, the calculated ratio will be 1:1. If the ratio between F1 and F2 is 1, it can be determined that the driver is gazing straight ahead. However, errors may occur in F1 or F2, so the ratio value of F1 and F2 (=F2/F1) may not be exactly 1. Therefore, if the ratio between F1 and F2 is within a predetermined range (e.g., 0.8˜1.3), it can be determined that the driver is gazing straight ahead.

In case (b), let F3 be the distance between the x-coordinate of the left eye center and the x-coordinate of the nose center, and F4 be the distance between the x-coordinate of the right eye center and the x-coordinate of the nose center. Since the driver's face is turned 45 degrees to the right, F3 will be larger than F4. For example, if the value of F4/F3 is 3/1=3, then F4/F3 is larger than the reference value (e.g., 1.3). In this case, the electronic device can determine that the driver is gazing to the right, that is, not gazing straight ahead. This reference value can be set considering measurement errors of F3 or F4 and/or the normal range of driver facial movements.

In case (c), since the center of the left eye is not recognized, the distance between the x-coordinate of the left eye and the x-coordinate of the nose center (F5: not shown) becomes 0, and only the distance between the x-coordinate of the right eye center and the x-coordinate of the nose center (=F6) is recognized. Therefore, the value of F6/F5 becomes infinite, and in this case, the electronic device can determine that the driver is gazing 90 degrees to the right, that is, not gazing straight ahead.

In a similar way to FIG. 23, when the driver rotates their face to the left, if the ratio between (the distance between the x-coordinate of the left eye center and the x-coordinate of the nose center) and (the distance between the x-coordinate of the right eye center and the x-coordinate of the nose center) is less than a certain value (e.g., 0.8), the electronic device can determine that the driver is gazing to the left, that is, not gazing straight ahead.

Thus, as in the example of FIG. 23, when one feature portion itself such as eyes, nose, and mouth is set as one feature point, the electronic device can determine the ratio value between the distance in x-coordinates between the center point of the left eye and the center point of the nose, and the distance between the center point of the right eye and the center point of the nose. If the determined ratio value is greater than or equal to a first value (e.g., 1.3), or less than a second value (e.g., 0.8), it can be determined that the driver is not gazing straight ahead. Also, if the determined ratio value is less than the first value (e.g., 1.3) and greater than or equal to the second value (e.g., 0.8), it can be determined that the driver is gazing straight ahead.

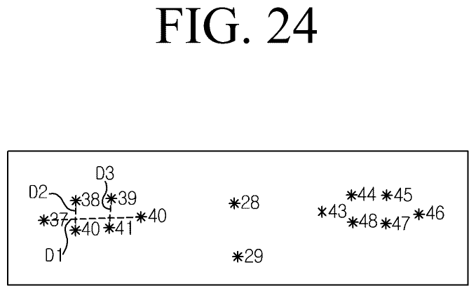

FIG. 24 is a diagram explaining an example of determining whether the driver is in a drowsy driving state using the feature points of FIG. 22 according to the second embodiment of the present invention.

The feature points in FIG. 24 are the left eye feature points (37-42), right eye feature points (43-48), and some of the nose feature points (28, 29) from FIG. 22.

The electronic device can determine whether the driver is in a drowsy state using these feature points. Specifically, the electronic device can determine the driver's drowsiness based on the ratio between the distance between the end points of the eye and the sum of the distances between the upper and lower feature points of the driver's eye.

For example, let D1 be the distance between feature points 37 and 40 of the left eye, D2 be the distance between feature points 38 and 42, and D3 be the distance between feature points 39 and 41. The degree of eye closure (C) can be expressed as (D2+D3)/(2×D1). The D1 is the distance between the end points of the driver's eye and this value does not change. D2 and D3 are both distances between the upper feature points of the eye and their corresponding lower feature points. When the driver's eye closes, both D2 and D3 values decrease. Therefore, (D2+D3)/(2×D1) becomes the ratio between the distance between the eye's end points (=D1) and the sum of distances between the upper feature points of the eye and their corresponding lower feature points (D2+D3). For reference, the 2 multiplied by D1 is for calculation convenience. In this way, the degree of eye closure (C) can be determined using the distances between multiple feature points detected from the eye.

The same method can be applied to determine the degree of eye closure for the right eye. Using this method, the electronic device can determine the degree of eye closure using the distances between feature points detected from the eyes, and if the degree of eye closure remains below a reference value for a certain period of time, the electronic device can determine that the user is in a drowsy driving state.

Meanwhile, if the electronic device supports machine learning, the electronic device can determine whether the driver is in a drowsy driving state by learning at least some of the feature points in FIG. 24 based on machine learning. That is, the electronic device can use the feature points in FIG. 23 as input data and determine the driver's drowsy driving state and gaze direction using a model such as support vector machine (SVM). In one embodiment, the driver's state can be classified as either normal or drowsy, and the driver's gaze direction can be classified as one of: straight ahead, 90 degrees left, 45 degrees left, 45 degrees right, or 90 degrees right.

As explained in FIGS. 21 to 24, the electronic device can determine whether the driver is gazing straight ahead and/or in a drowsy driving state using feature points detected from the driver's face. Accordingly, if it is determined that the driver is not gazing straight ahead and/or is in a drowsy driving state, the electronic device can provide warning notifications to the driver through alert sounds or other means.

The embodiments of the present invention have been explained so far. The functions, methods, and procedures of the vehicle electronic device, vehicle service providing server, and user terminal device disclosed in this specification can be implemented through software. The constituent means of each function, method, and procedure are code segments that perform necessary tasks. Programs or code segments can be stored in processor-readable media or transmitted via transmission media or communication networks as computer data signals coupled with carrier waves.

The computer-readable recording medium includes all types of recording devices that can be read by computer systems. Examples of computer-readable recording devices include ROM, RAM, CD-ROM, DVD±ROM, DVD-RAM, magnetic tape, floppy disk, hard disk, optical data storage devices, etc. Additionally, the computer-readable recording medium may be distributed across network-coupled computer devices so that computer-readable code is stored and executed in a distributed fashion.

The embodiments described above are not limited by the embodiments and accompanying drawings as they can be modified in various ways without departing from the technical spirit of the invention for those skilled in the art to which the invention pertains. Also, the embodiments described in this document are not intended to be limitedly applied, but various modifications can be made by selectively combining all or parts of each embodiment.

1. A method of operating an electronic device for monitoring a driver's state, comprising:
detecting feature points of a driver's face in a vehicle interior image captured by an interior camera installed in the electronic device;
transforming coordinates of the detected feature points into a frontal coordinate system; and
determining the driver's state using distances between coordinates of at least two of the transformed feature points,
wherein the frontal coordinate system is a coordinate system of an image captured by the interior camera from directly in front of the driver's face.

2. The method of claim 1, wherein transforming the coordinates into coordinates in the frontal coordinate system comprises:
acquiring a mounting angle of the interior camera; and
transforming the coordinates of the feature points into coordinates in the frontal coordinate system using the mounting angle of the interior camera.

3. The method of claim 2, wherein acquiring the mounting angle of the interior camera comprises:
detecting straight lanes in a front image captured by a front camera equipped in the electronic device;
detecting a vanishing point of the detected straight lanes;
acquiring a mounting angle of the front camera by comparing the detected vanishing point with a center point of the front image; and
acquiring the mounting angle of the interior camera from the mounting angle of the front camera.

4. The method of claim 3, wherein acquiring the mounting angle of the interior camera comprises:
acquiring the mounting angle of the interior camera using a gyro sensor;
weighted summing the mounting angle of the interior camera acquired from the mounting angle of the front camera and the mounting angle of the interior camera acquired using the gyro sensor; and
determining the weighted summed value as a final mounting angle of the interior camera.

5. The method of claim 1, wherein:
detecting the feature points of the driver's face comprises detecting a center point of a left eye as a first feature point, a center point of a right eye as a second feature point, and a center point of a nose as a third feature point; and
determining the driver's state is based on a ratio of the distance between the first and third feature points to the distance between the second and third feature points.

6. The method of claim 5, wherein determining the driver's state comprises:
determining the driver's state as not gazing forward when the ratio of distances is greater than or equal to a first reference value, or less than a second reference value; and
determining the driver's state as gazing forward when the ratio of distances is greater than or equal to the second reference value and less than the first reference value.

7. The method of claim 1, wherein:
at least multiple feature points among the detected feature points of the driver's face are detected from one feature portion among feature portions of the driver's face; and
the feature portions of the driver's face include at least one of eyes, nose, mouth, eyebrows, and facial contour lines.

8. The method of claim 7, wherein determining the driver's state comprises:
determining the driver's state, for at least one eye among the driver's left eye and right eye, based on a ratio (C), where (C) is the ratio of the distance between the end feature points of the one eye to the sum of distances between at least one upper eye feature point and its corresponding lower eye feature point.

9. The method of claim 8, wherein determining the driver's state comprises:
determining the driver's state as drowsy when the ratio (C) remains less than or equal to a third reference value for at least a predetermined time period.

10. The method of claim 7, wherein determining the driver's state comprises:
determining at least one of the driver's drowsiness and the driver's forward gaze state by a machine learning model trained with at least some of the detected feature points of the driver's face.

11. An electronic device for monitoring a driver's state, comprising:
an interior camera configured to capture a vehicle interior; and
a processor configured to:
detect feature points of a driver's face in a vehicle interior image captured by the interior camera,
transform coordinates of the detected feature points into coordinates in a frontal coordinate system, and
determine the driver's state using distances between coordinates of at least two of the transformed feature points,
wherein the frontal coordinate system is a coordinate system of an image captured by the interior camera from directly in front of the driver's face.

12. The electronic device of claim 11, wherein the processor is configured to:
acquire a mounting angle of the interior camera; and
transform the coordinates of the feature points into coordinates in the frontal coordinate system using the mounting angle of the interior camera.

13. The electronic device of claim 12, wherein the processor is configured to:
detect straight lanes in a front image captured by a front camera equipped in the electronic device;
detect a vanishing point of the detected straight lanes;
acquire a mounting angle of the front camera by comparing the detected vanishing point with a center point of the front image; and
acquire the mounting angle of the interior camera from the mounting angle of the front camera.

14. The electronic device of claim 13, wherein the processor is configured to:
acquire the mounting angle of the interior camera using a gyro sensor;
perform a weighted summation of the mounting angle of the interior camera acquired from the mounting angle of the front camera and the mounting angle of the interior camera acquired using the gyro sensor; and
determine the weighted summed value as a final mounting angle of the interior camera.

15. The electronic device of claim 11, wherein the processor is configured to:
detect the feature points of the driver's face by detecting a center point of a left eye as a first feature point, a center point of a right eye as a second feature point, and a center point of a nose as a third feature point; and
determine the driver's state based on a ratio of the distance between the first and third feature points to the distance between the second and third feature points.

16. The electronic device of claim 15, wherein the processor is configured to:
determine the driver's state as not gazing forward when the ratio of distances is greater than or equal to a first reference value, or less than a second reference value; and
determine the driver's state as gazing forward when the ratio of distances is greater than or equal to the second reference value and less than the first reference value.

17. The electronic device of claim 11, wherein:
at least multiple feature points among the detected feature points of the driver's face are detected from one feature portion among feature portions of the driver's face; and
the feature portions of the driver's face include at least one of eyes, nose, mouth, eyebrows, and facial contour lines.

18. The electronic device of claim 17, wherein the processor is configured to:
determine the driver's state based on a ratio (C), where (C) is the ratio of the distance between end feature points of one eye among multiple eye feature points detected from at least one eye among the driver's left eye and right eye, to a sum of distances between at least one upper eye feature point and its corresponding lower eye feature point of the one eye.

19. The electronic device of claim 18, wherein the processor is configured to:
determine the driver's state as drowsy when the ratio (C) remains less than or equal to a third reference value for at least a predetermined time period.

20. The electronic device of claim 17, wherein the processor is configured to:
determine at least one of the driver's drowsiness and the driver's forward gaze state by a machine learning model trained with at least some of the detected feature points of the driver's face.
